(19) United States
(12) Patent Application Publication
(10) Pub. No.: US 2008/0063193 A1
(43) Pub. Date: Mar. 13, 2008

(54) CRYPTO-COMMUNICATION METHOD, RECIPIENT-SIDE DEVICE, KEY MANAGEMENT CENTER-SIDE DEVICE AND PROGRAM

(76) Inventor: Mototsugu Nishioka, Musashimurayama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/830,947

(22) Filed: Jul. 31, 2007

(30) Foreign Application Priority Data
Jul. 31, 2006 (JP) 2006-207310
Jun. 8, 2007 (JP) 2007-153280

(51) Int. Cl. H04L 9/30; G06F 7/58; H04L 9/28

(52) U.S. Cl. 380/46; 380/277; 380/30

(57) ABSTRACT

A public key encryption system and an ID-based encryption system are provided, each exhibiting high security and having a tight security reduction, in which a BDH problem is a cryptographic assumption. A recipient-side device (110) serving as a recipient of a cryptogram selects random numbers s₁ and s₂, generates P, QεG₁ and a bilinear mapping e: G₁×G₁→G₂ as part of public key information, and further generates P₁=s₁P and P₂=s₂P as part of the public key information. A sender-side device (120) serving as a sender of the cryptogram calculates e(Q, P₁) and e(Q, P₂) by use of the public key information Q of the recipient-side device (110) and the bilinear mapping e, and further generates a cryptogram to be transmitted to the recipient-side device (110) by use of those pieces of information e(Q, P₁) and e(Q, P₂).

### INCORPORATION BY REFERENCE

This application claims a priority based on Japanese patent application Nos. 2006-207310 filed on Jul. 31, 2006 and 2007-153280 filed on Jun. 8, 2007, the entire contents of which are incorporated herein by reference.

### BACKGROUND OF THE INVENTION

The present invention relates to a technology for crypto-communications.

A public key encryption system involves registering a public key generated by a user with a certificate authority (CA) and having the CA issue a certificate. That is, a sender of a cryptogram obtains a public key of a recipient and a certificate as a basis for validity of the key, and in addition, needs to encrypt a message text to be transmitted.

By contrast, another proposed encryption system is an encryption system aiming at managing a public key in a simpler way by omitting the task of issuing the certificate by the CA, and using ID information of a user as a public key (hereinafter referred to as ID-based encryption system).

The ID-based encryption system entails using algorithms corresponding to applications for the purpose of the crypto-communications and authentication (such as a digital signature and individual authentication).

For example, in the case of the crypto-communications, the user registers self-ID information as a public key with a key management center and has the key management center issue a private key, which is associated with the ID information. The sender of the cryptogram generates a cryptogram by use of the ID information of the recipient and a system parameter generated by the key management center, and sends the cryptogram thus generated to the recipient. The recipient decrypts the encrypted message with the private key.

The public key encryption system uses a random bit string as the recipient's public key, and, by contrast, the ID-based encryption system uses private information system such as a mail address as the public key, thus facilitating handling thereof and enabling the need for the certificate to be eliminated.

A great number of ID-based encryption systems have been proposed, but for a long time no system capable of proving security has been known. In the year of 2001, however, Boneh and M. Franklin, Identity Based Encryption From the Weil Pairing (hereinafter referred to as Non-Patent Document 1) proposed a first ID-based encryption scheme capable of proving security by utilizing a characteristic of a bilinear mapping on an elliptic curve. A system in Non-Patent Document 1 makes use of a conversion method disclosed in E. Fujisaki and T. Okamoto, Secure Integration of Asymmetric and Symmetric Encryption Schemes, Crypto'99, LNCS1666, Springer-Verlag, pp. 537-554 (1999) (hereinafter referred to as Non-Patent Document 2), in order to enhance security.

Thereafter, a variety of encryption systems utilizing the bilinear mapping have been proposed. Non-Patent Document 2 proposed a hierarchical ID-based encryption scheme capable of proving security in a hierarchized system based on the encryption system disclosed in Non-Patent Document 1.

C. Gentry and A. Silverberg, Hierarchical ID-based Cryptography, http://eprint.iacr.org/2002/056 (hereinafter referred to as Non-Patent Document 3) proposed an idea for realizing tight security reduction in proving security, while J. Katz, N. Wang, Efficiency Improvements for Signature Schemes with Tight Security Reductions, http://www.cs.umd.edu/˜jkatz/ (hereinafter referred to as Non-Patent Document 4) specifically proposed an ID-based encryption system having the tight security reduction by applying the same idea.

Non Patent Document 5: N. Attrapadung, J. Furukawa, T. Gomi, G. Hanaoka, H. Imai, R. Zhang, Identity-Based Encryption Schemes with Tight Security Reductions, http://eprint.iacr.org/2005/320

### SUMMARY OF THE INVENTION

Many cryptography systems proposed over recent years are capable of provable security of the cryptograms. That is, a calculation cost for breaking the cryptography is quantitatively evaluated by replacing as a problem (e.g., a unique factorization problem, a discrete logarithm problem, a Diffie-Hellman problem) having computational complexity, such as a number theory problem.

The security reduction is a measure indicating how the strength of the underlying intractable problem, which is used as a cryptographic assumption, is preserved in the underlying scheme's security. The security reduction being tight means that the security of the cryptography is close to the computational intractability of the number theory problem serving as the cryptographic assumption.

This implies, as compared with an encryption system having a poor (non-tight) security reduction, that the encryption system with the tight security reduction has higher security, and also has a merit of enabling shortening a key length necessary for obtaining a fixed level of security.

Herein, even when the security reduction is tight, the security of the cryptography loses its meaning if the computational number theory problem used for the cryptographic assumption is tractable. Hence, with respect to such a problem in which computational intractability is more likely, an ideal encryption system is an encryption system having tight security reduction and being capable of proving the security.

The present invention provides a public key encryption system and an ID-based encryption system each exhibiting high security and characterized by having tight security reduction, in which a Bilinear Diffie-Hellman (BDH) problem, of which the computational intractability is sufficiently likely, is used as the cryptographic assumption.

Further, the present invention also provides, in a case where there has already existed an encryption system using cryptography having tight security reduction for a List Bilinear Diffie-Hellman (LBDH) problem which is computationally easier than the BDH problem, a method which converts the existing encryption system into an encryption system employing the cryptography having tight security reduction for the BDH problem, not by replacing cryptographic parts but by employing the already-used cryptography.

For solving the problem given above, according to the present invention, random numbers s₁, s₂ are selected with respect to a bilinear mapping e: G₁×G₁→G₂, P, QεG₁, and P₁=s₁P and P₂=s₂P are generated as part of key information open to the public. A sender of the cryptogram calculates e(Q, P₁) and e(Q, P₂) and generates the cryptogram by use of those values. One specific example of the public key cryptography to be realized will be described.

For example, according to the present invention, there is provided a crypto-communication method by which a sender-side device generates and transmits a cryptogram of a message text and a recipient-side device receives and decrypts the cryptogram, the crypto-communication method including the steps performed by one of the recipient-side device and a key management center-side device of:

selecting random numbers s₁, s₂;

generating P, QεG₁ and a bilinear mapping e: G₁×G₁→G₂ as part of key information open to the public;

generating P₁=s₁P and P₂=s₂P as part of the key information open to the public; and

transmitting the generated P, Q, e, P₁, P₂ to the sender-side device; and the crypto-communication method further including the steps performed by the sender-side device of:

receiving P, Q, e, P₁, P₂ from the one of the recipient-side device and the key management center-side device;

calculating e(Q, P₁) and e(Q, P₂) by use of the received P, Q, e, P₁, P₂; and

generating a cryptogram to be transmitted to the recipient-side device by use of the calculated e(Q, P₁) and e(Q, P₂).

Further, according to the present invention, there is provided a crypto-communication method by which a sender-side device generates and transmits a cryptogram of a message text and a recipient-side device receives and decrypts the cryptogram,

(1) the crypto-communication method including the steps performed by the recipient-side device of:

generating a prime number q, an additive group G₁ of an order q, a multiplicative group G₂ of the order q, and a bilinear mapping e given from Equation 66;

[Equation 66]
e:G₁×G₁→G₂ (66)

selecting at random s₁, s₂εZ*_{q} and P, QεG₁;

calculating Equation 67;

$$\begin{matrix}[ Equation 67 ] & \\ \begin{matrix}{P}_{pub , 1} = {s}_{1} P , \\ {P}_{pub , 2} = {s}_{2} P\end{matrix} \} & ( 67 )\end{matrix}$$

setting SK_{A}=(s₁Q, s₂Q) as a decryption key and PK_{A}=(q, G₁, G₂, e, m, n, P, P_{pub,1}, P_{pub,2}, H₁, H₂) as an encryption key, and storing the decryption key and the encryption key in a storage unit (where m and n represent natural numbers, and H₁, H₂ denote hash functions given by Equation 68); and

$$\begin{matrix}[ Equation 68 ] & \\ \begin{matrix}{H}_{1} : {G}_{2} \times {G}_{2} \to {\{ 0 , 1 \}}^{n} , \\ {H}_{2} : {G}_{1} \times {\{ 0 , 1 \}}^{n} \times {\{ 0 , 1 \}}^{n} \to {\{ 0 , 1 \}}^{m}\end{matrix} \} & ( 68 )\end{matrix}$$

outputting the encryption key PK_{A};

(2) the crypto-communication method further including the steps performed by the sender-side device of:

selecting at random rεZ_{q} with respect to a message text M ε{0,1}ⁿ;

calculating Equation 69 by use of the encryption key PK_{A} output by the recipient-side device; and

$$\begin{matrix}[ Equation 69 ] & \\ \begin{matrix}U = rP , \\ V = M ⊕ {H}_{1} ( {e ( Q , {P}_{1} )}^{r} , {e ( Q , {P}_{2} )}^{r} ) , \\ W = {H}_{2} ( U , V , M )\end{matrix} \} & ( 69 )\end{matrix}$$

transmitting calculated ciphertex tc=(U, V, W) as a cryptogram of the message text M to the recipient-side device; and

(3) the crypto-communication method further including the steps performed by the recipient-side device of:

calculating Mε{0,1}ⁿ from Equation 70 by use of the decryption key SK_{A} stored in the storage unit with respect to the cryptogram C=(U, V, W) received from the sender-side device;

[Equation 70]
M=V⊕H₁(e(s₁Q,U),e(s₂Q,U)) (70)

checking whether a checking formula in Equation 71 is satisfied or not; and

[Equation 71]
W=H₂(U,V,M) (71)

outputting a calculation result M as the message text if the checking formula is satisfied, and discarding the cryptogram C as an invalid cryptogram if the checking formula is not satisfied.

Still further, according to the present invention, there is provided a crypto-communication method by which a sender-side device generates and transmits a cryptogram of a message text and a recipient-side device receives and decrypts the cryptogram, the crypto-communication method including the steps performed by one of the recipient-side device and a key management center-side device of:

generating a plurality of pairs of public keys and secret keys;

generating public key information containing multiple number of the public keys generated in the step of generating keys; and

generating secret key information containing multiple number of the secret keys generated in the step of generating keys; the crypto-communication method further including the steps performed by the sender-side device of:

acquiring the public key information; and

generating a cryptogram in which a message is encrypted by using all of the multiple number of the public keys contained in the public key information; and the crypto-communication method further including the steps performed by the recipient-side device of:

acquiring the cryptogram; and

decrypting the cryptogram by using the secret key information.

According to the encryption system of the present invention, it is feasible to provide the public key encryption system and the ID-based encryption system each exhibiting high security and having tight security reduction, in which the BDH problem, of which the computational intractability is sufficiently expected, is the cryptographic assumption. This enables realization of a crypto-communication method, an applied device and system thereof, which are very convenient and are secure.

Yet further, a new encryption method may be provided while utilizing existing encryption systems, and it is therefore possible to realize a crypto-communication method, and an applied device and system thereof, which can reduce cost for system replacement and are secure.

### BRIEF DESCRIPTION OF THE DRAWINGS

In the accompanying drawings:

FIG. 1 is a schematic diagram of a communication system common to a first embodiment and a second embodiment of the present invention;

FIG. 2 is a schematic diagram showing a recipient-side device;

FIG. 3 is a schematic diagram showing a sender-side device;

FIG. 4 is a schematic diagram showing a computer;

FIG. 5 is an explanatory diagram of operation procedures in the first embodiment of the present invention;

FIG. 6 is an explanatory diagram of operation procedures in the second embodiment of the present invention;

FIG. 7 is a schematic diagram of a communication system common to a third embodiment and a fourth embodiment of the present invention;

FIG. 8 is a schematic diagram showing a recipient-side device and a sender-side device;

FIG. 9 is a schematic diagram showing a key management center-sided device;

FIG. 10 is an explanatory diagram of operation procedures in the third embodiment of the present invention;

FIG. 11 is an explanatory diagram of operation procedures in the fourth embodiment of the present invention;

FIG. 12 is a schematic diagram of a communication system in a fifth embodiment, a sixth embodiment, a seventh embodiment, and an eighth embodiment of the present invention;

FIG. 13 is a schematic diagram showing a recipient-side device;

FIG. 14 is a schematic diagram showing a sender-side device;

FIG. 15 is an explanatory diagram of operation procedures in the fifth embodiment of the present invention;

FIG. 16 is an explanatory diagram of operation procedures in the sixth embodiment of the present invention;

FIG. 17 is an explanatory diagram of operation procedures in the seventh embodiment of the present invention;

FIG. 18 is an explanatory diagram of operation procedures in the eighth embodiment of the present invention;

FIG. 19 is a schematic diagram of a communication system in a ninth embodiment, a tenth embodiment, an eleventh embodiment and a twelfth embodiment of the present invention;

FIG. 20 is a schematic diagram showing a recipient-side device 910A and a sender-side device;

FIG. 21 is a schematic diagram showing a key management center-sided device;

FIG. 22 is an explanatory diagram of operation procedures in the ninth embodiment of the present invention;

FIG. 23 is an explanatory diagram of operation procedures in the tenth embodiment of the present invention;

FIG. 24 is an explanatory diagram of operation procedures in the eleventh embodiment of the present invention; and

FIG. 25 is an explanatory diagram of operation procedures in the twelfth embodiment of the present invention.

### DESCRIPTIONS OF THE PREFERRED EMBODIMENTS

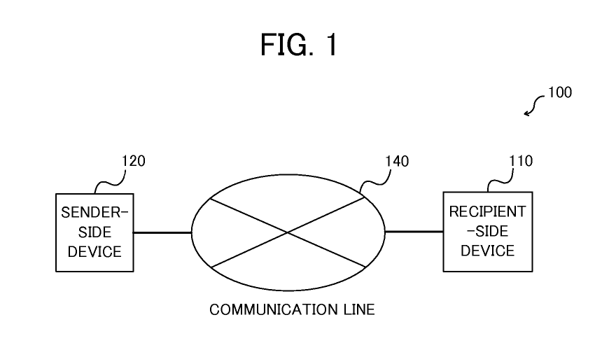

FIG. 1 is a schematic diagram of a communication system 100 common to a first embodiment and a second embodiment of the present invention.

As illustrated in FIG. 1, the communication system 100 includes a recipient-side device 110 and a sender-side device 120, which are connected to a communication line 140.

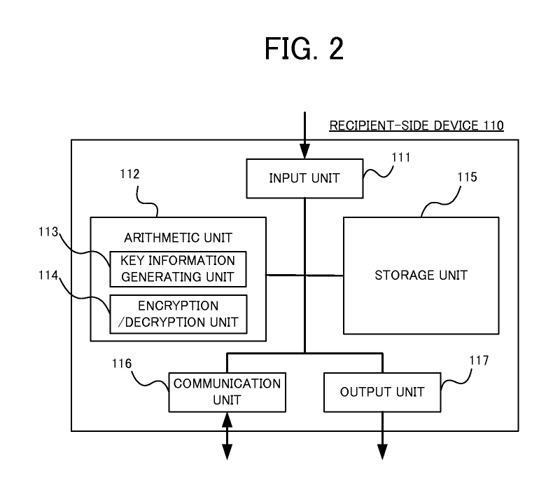

FIG. 2 is a schematic diagram showing the recipient-side device 110.

As illustrated in FIG. 2, the recipient-side device 110 includes an input unit 111 which is used to input information, an arithmetic unit 112 which performs a variety of operations including a logical operation, exponentiation, a remainder operation, a hash function operation and a random function operation, and controls the respective units of the recipient-side device 110, a storage unit 115, a communication unit 116 which communicates with the sender-side device 120 via a communication line 140, and an output unit 117 which outputs the information.

Further, the arithmetic unit 112 has a key information generating unit 113 which generates an encryption key and a decryption key, and an encryption/decryption unit 114 which executes an encryption/decryption process.

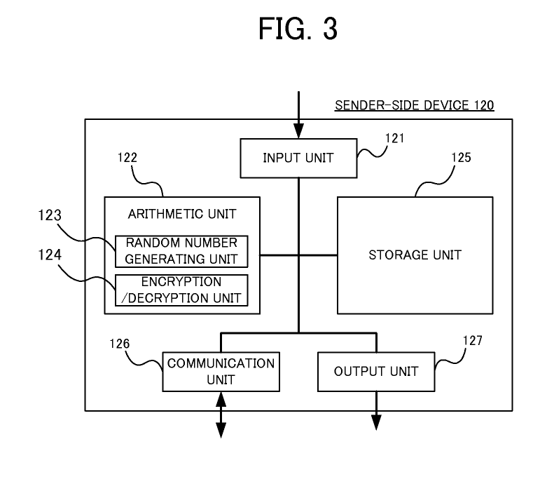

FIG. 3 is a schematic diagram showing the sender-side device 120.

As illustrated in FIG. 3, the sender-side device 120 has an input unit 121 which is used to input the information, an arithmetic unit 122 which performs a variety of operations including a logical operation, exponentiation, a remainder operation, and the hash function operation, and controls the respective units of the sender-side device 120, a storage unit 125, a communication unit 126 which communicates with the recipient-side device 110 via the communication line 140, and an output unit 127 which outputs the information.

Moreover, the arithmetic unit 122 has a random number generating unit 123 which generates random numbers, and an encryption/decryption unit 124 which executes an encryption/decryption process.

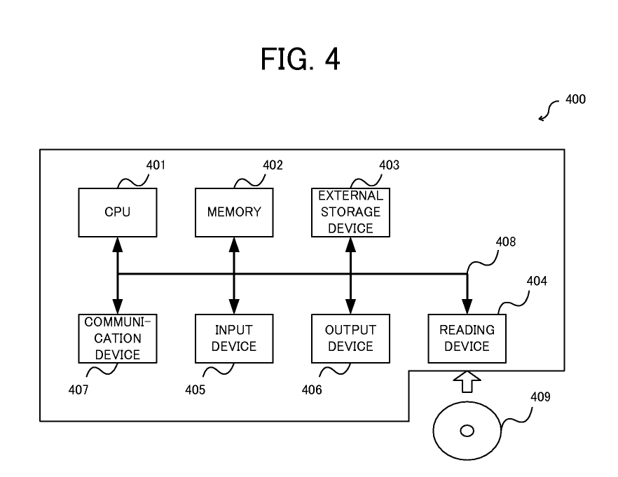

The recipient-side device 110 and sender-side device 120 having the above configuration can be realized so that a CPU 401 executes predetermined programs (program code) loaded into a memory 402 in a general type of computer 400 including, as illustrated in FIG. 4, CPU 401, memory 402, an external storage device 403 such as a HDD, a reading device 404 which reads the information from a storage medium 409 having portability as in cases of a CD-ROM and a DVD-ROM, an input device 405 such as a keyboard and a mouse, an output device 406 such as a display, a communication device 407 which communicates with a partner communication device via a communication line 300, and a bus 408 which connects the respective devices to each other. In this case, the memory 402 and the external storage device 403 are utilized for the storage units 115, 125, the communication device 408 is utilized for the communication units 116, 126, the input device 406 and the reading device 405 are employed for the input units 111, 121, and the output device 407 is used for the output units 117, 127.

The predetermined programs (program code) may also be downloaded into the external storage device 403 from the storage medium 409 via the reading device 404 or from a communication line 140 via the communication device 407, and loaded into the memory 402, in which the CPU 401 may execute the programs. Further, the programs may also be loaded directly into the memory 402 from the storage medium 409 via the reading device 404 or from the communication line 140 via the communication device 407, in which the CPU 401 may execute the programs.

Note that, the programs can be provided as a program product while being stored on the storage medium.

### First Embodiment

Hereinafter, a first embodiment of the present invention will be described.

The first embodiment will exemplify a method by which a user A employing the recipient-side device 110 and a user B using the sender-side device 120 perform crypto-communications with each other via the communication line 140 by using the public key information generated by the user A in the recipient-side device 110.

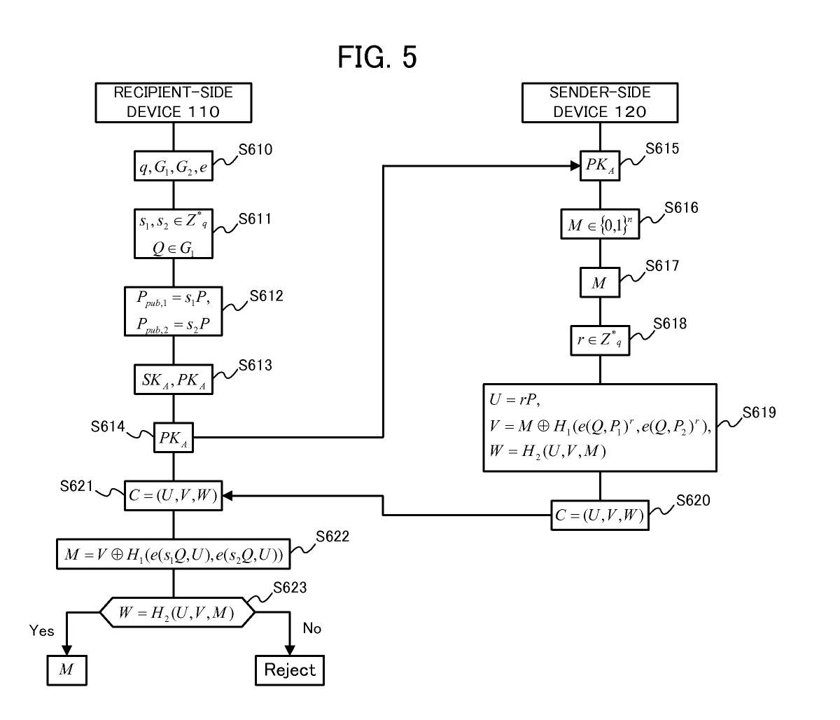

Note that, FIG. 5 is an explanatory diagram showing operation procedures in the first embodiment of the present invention.

1. Processes in Recipient-Side Device 110

In the recipient-side device 110, the arithmetic unit 112, when accepting a key generating instruction from the user A via the input unit 111, generates a prime number q, an additive group G₁ of an order q, a multiplicative group G₂ of the order q and a bilinear mapping e given from Equation 72 by use of the key information generating unit 113 (S610).

[Equation 72]
e:G₁×G₁→G₂ (72)

Next, the arithmetic unit 112 selects at random s₁, s₂εZ*_{q} and P, QεG₁ by employing the key information generating unit 113 (S611).

Then, the key information generating unit 113 of the arithmetic unit 112 generates Equation 73 by using s₁, s₂ and P selected at random (S612).

$$\begin{matrix}[ Equation 73 ] & \\ \begin{matrix}{P}_{pub , 1} = {s}_{1} P , \\ {P}_{pub , 2} = {s}_{2} P\end{matrix} \} & ( 73 )\end{matrix}$$

Then, the arithmetic unit 112 sets SK_{A}=(s₁Q,s₂Q) as a decryption (secret) key and PK_{A}=(q, G₁, G₂, e, m, n, P, P_{pub,1}, P_{pub,2}, H₁, H₂) as an encryption (public) key, and stores both the keys in the storage unit 115 (S613). m and n represent natural numbers, and H₁, H₂ denote hash functions given by Equation 74.

$$\begin{matrix}[ Equation 74 ] & \\ \begin{matrix}{H}_{1} : {G}_{2} \times {G}_{2} \to {\{ 0 , 1 \}}^{n} , \\ {H}_{2} : {G}_{1} \times {\{ 0 , 1 \}}^{n} \times {\{ 0 , 1 \}}^{n} \to {\{ 0 , 1 \}}^{m}\end{matrix} \} & ( 74 )\end{matrix}$$

Next, the arithmetic unit 112 outputs from the output unit 117 the encryption (public) key PK_{A}=(q, G₁, G₂, e, m, n, P, P_{pub,1}, P_{pub,2}, H₁, H₂) generated in S613, or alternatively transmits the encryption (public) key PKA to the sender-side device 120 from the communication unit 116 via the communication line 140 (S614). It is to be noted that if the encryption (public) key PK_{A} is output from the output unit 117, the user A notifies the user B of the encryption (public) key PK_{A} by post, or the like.

2. Processes in Sender-Side Device 120

The arithmetic unit 122 of the sender-side device 120 stores the encryption (public) key PK_{A} received by the communication unit 126 from the recipient-side device 110 via the communication line 140 or input by the user B via the input unit 121 in the storage unit 125 (S615).

Next, the user B inputs a message text Mε{0,1}ⁿ (n is a positive integer) via the input unit 121 (S616).

Upon inputting the message text M, the arithmetic unit 122 stores the input message text M in the storage unit 125 (S617).

Then, the arithmetic unit 122 selects at random rεZ*_{q} with respect to the message M by employing the random number generating unit 123 (S618).

Subsequently, the arithmetic unit 122 calculates Equation 75 by use of r selected in S616, the encryption (public) key PK_{A} stored in the storage unit 125, the message M and the encryption/decryption unit 124 (S619).

$$\begin{matrix}[ Equation 75 ] & \\ \begin{matrix}U = rP , \\ V = M ⊕ {H}_{1} ( {e ( Q , {P}_{1} )}^{r} , {e ( Q , {P}_{2} )}^{r} ) , \\ W = {H}_{2} ( U , V , M )\end{matrix} \} & ( 75 )\end{matrix}$$

Then, the arithmetic unit 122 outputs a cryptogram C=(U, V, W) generated in S619 from the output unit 127, or alternatively transmits the cryptogram C to the recipient-side device 110 from the communication unit 126 via the communication line 140 (S620). Note that if the cryptogram C is outputted from the output unit 127, the user B notifies the user A of the cryptogram C by post, or the like.

3. Processes in Recipient-Side Device 110

The arithmetic unit 112 of the recipient-side device 110 stores the cryptogram C received by the communication unit 116 from the sender-side device 120 via the communication line 140 or input by the user A via the input unit 111 in the storage unit 115 (S621).

Next, the arithmetic unit 112, by use of the encryption/decryption unit 114, calculates Mε{0,1}ⁿ in Equation 76 from the decryption (secret) key SK_{A} of the user A stored in the storage unit 115 with respect to the cryptogram C stored in the storage unit 115 (S622).

[Equation 76]
M=V⊕H₁(e(s₁Q,U),e(s₂Q,U)) (76)

Further, the arithmetic unit 112 checks, from M defined as a result of the calculation in S622 and from the cryptogram C=(U, V, W), whether a checking formula in Equation 77 is satisfied or not (S623).

[Equation 77]
W=H₂(U,V,M) (77)

If the checking formula is satisfied, the calculation result M in S620 is output as the message text. If the checking formula is not satisfied, the cryptogram C=(U, V, W) is considered to be an invalid cryptogram and is therefore discarded.

The public key crypto-communication method described in the first embodiment is capable of proving, in the same way as disclosed in Non-Patent Document 1 and Non-Patent Document 4, the security in the sense of IND-CCA2 (INDistinguishability under adaptive Chosen Ciphertext Attack), wherein the computational intractability of the Bilinear Diffie-Hellman (BDH) problem is used as a cryptographic assumption. Here, supposing that there exists an algorithm capable of breaking the public key encryption system in the first embodiment with an advantage ε in the sense of IND-CCA2, it is shown that an algorithm capable of solving the BDH problem substantially with the advantage ε by use of the former algorithm can be built up. It is recognized from this point that the public key encryption system according to the first embodiment has a tight security reduction.

It is also feasible to generate the cryptogram and to decrypt the message with the same procedures as described above by changing an input value to W defined as part of the cryptogram, to another parameter utilized in the present system in the crypto-communication method according to the first embodiment.

Further, the encryption system in the first embodiment involves using the plurality of hash functions; however, though capable of organizing such a plurality of functions so as to obtain different output values by previously setting plural values serving as seeds separately from the input values with respect to the single hash function, the hash function can be also given by this type of method.

### Second Embodiment

Next, a second embodiment of the present invention will be described. The second embodiment is a modified example of the first embodiment.

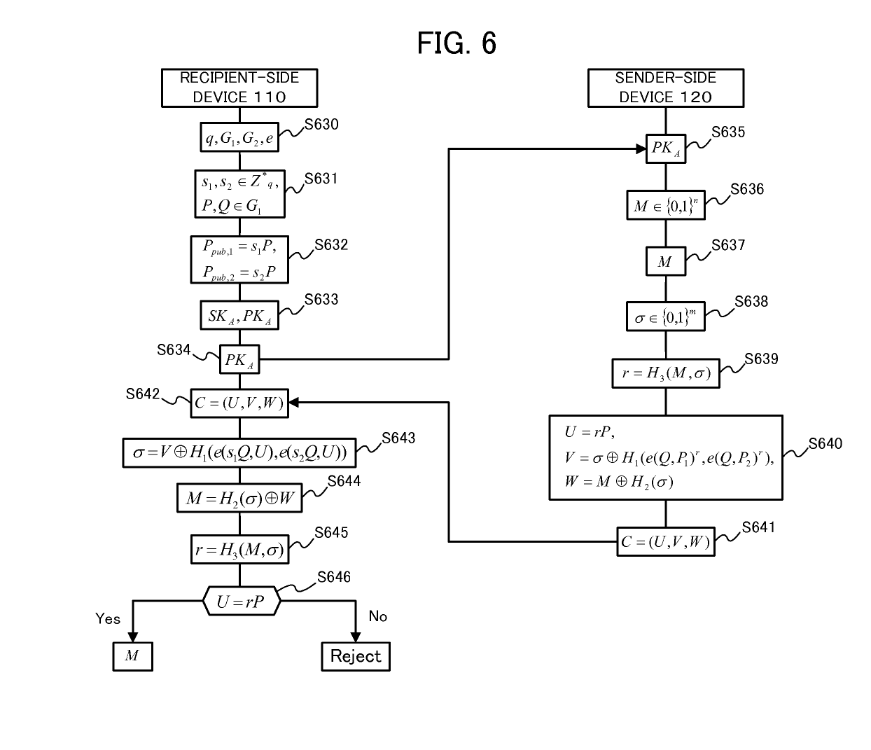

FIG. 6 is an explanatory diagram showing operation procedures in the second embodiment of the present invention.

1. Processes in Recipient-Side Device 110

In the recipient-side device 110, the arithmetic unit 112, when accepting a key generating instruction from the user A via the input unit 111, generates a prime number q, an additive group G1 of an order q, a multiplicative group G2 of the order q and a bilinear mapping e given from Equation 78 by use of the key information generating unit 113 (S630).

[Equation 78]
e:G₁×G₁→G₂ (78)

Next, the arithmetic unit 112 selects at random s₁, s₂εZ*_{q} and P, QεG₁ by employing the key information generating unit 113 (S631).

Then, the key information generating unit 113 of the arithmetic unit 112 generates Equation 79 by using s₁, s₂ and P selected at random (S632).

$$\begin{matrix}[ Equation 79 ] & \\ \begin{matrix}{P}_{pub , 1} = {s}_{1} P , \\ {P}_{pub , 2} = {s}_{2} P\end{matrix} \} & ( 79 )\end{matrix}$$

Then, the arithmetic unit 112 sets SK_{A}=(s₁Q,s₂Q) as a decryption (secret) key and PK_{A}=(q, G₁, G₂, e, m, n, P, P_{pub,1}, P_{pub,2}, H₁, H₂) as an encryption (public) key, and stores both the keys in the storage unit 115 (S633). m and n represent natural numbers, and H₁, H₂ denote hash functions given by Equation 80.

$$\begin{matrix}[ Equation 80 ] & \\ \begin{matrix}{H}_{1} : {G}_{2} \times {G}_{2} \to {\{ 0 , 1 \}}^{m} , \\ {H}_{2} : {\{ 0 , 1 \}}^{m} \to {\{ 0 , 1 \}}^{n} , \\ {H}_{3} : {\{ 0 , 1 \}}^{n} \times {\{ 0 , 1 \}}^{m} \to {ℤ}_{q}\end{matrix} \} & ( 80 )\end{matrix}$$

Next, the arithmetic unit 112 outputs from the output unit 117 the encryption (public) key PK_{A}=(q, G₁, G₂, e, m, n, P. P_{pub,1}, P_{pub,2}, H₁, H₂) generated in S633, or alternatively transmits the encryption (public) key PKA to the sender-side device 120 from the communication unit 116 via the communication line 140 (S634). It is to be noted that if the encryption (public) key PK_{A} is output from the output unit 117, the user A notifies the user B of the encryption (public) key PK_{A} by post, or the like.

2. Processes in Sender-Side Device 120

The arithmetic unit 122 of the sender-side device 120 stores the encryption (public) key PK_{A} received by the communication unit 126 from the recipient-side device 110 via the communication line 140 or input by the user B via the input unit 121 in the storage unit 125 (S635).

Next, the user B inputs a message text Mε{0,1}ⁿ (n is a positive integer) via the input unit 121 (S636).

Upon inputting the message text M, the arithmetic unit 122 stores the input message text M in the storage unit 125 (S637).

Then, the arithmetic unit 122 selects at random σε{0,1}ⁿ with respect to the message M by employing the random number generating unit 123 (S638).

Subsequently, the arithmetic unit 122 calculates Equation 81 by use of G selected in S638 (S639).

[Equation 81]
r=H₃(M,σ) (81)

Subsequently, the arithmetic unit 122 calculates Equation 82 by use of r calculated in S639, the encryption (public) key PK_{A} stored in the storage unit 125, the message M and the encryption/decryption unit 124 (S640).

$$\begin{matrix}[ Equation 82 ] & \\ \begin{matrix}U = rP , \\ V = σ ⊕ {H}_{1} ( {e ( Q , {P}_{1} )}^{r} , {e ( Q , {P}_{2} )}^{r} ) , \\ W = M ⊕ {H}_{2} ( σ )\end{matrix} \} & ( 82 )\end{matrix}$$

Then, the arithmetic unit 122 outputs a cryptogram C=(U, V, W) generated in S640 from the output unit 127, or alternatively transmits the cryptogram C to the recipient-side device 110 from the communication unit 126 via the communication line 140 (S641). Note that if the cryptogram C is output from the output unit 127, the user B notifies the user A of the cryptogram C by post, or the like.

3. Processes in Recipient-Side Device 110

The arithmetic unit 112 of the recipient-side device 110 stores the cryptogram C received by the communication unit 116 from the sender-side device 120 via the communication line 140 or input by the user A via the input unit 111 in the storage unit 115 (S642).

Next, the arithmetic unit 112, by use of the encryption/decryption unit 114, calculates σε{0,1}^{m} in Equation 83 from the decryption (secret) key SK_{A} of the user A stored in the storage unit 115 with respect to the cryptogram C stored in the storage unit 115 (S643).

[Equation 83]
σ=V⊕H₁(e(s₁Q,U),e(s₂Q,U)) (83)

Further, the arithmetic unit 112 calculates Mε{0,1}ⁿ in Equation 84 from σ defined as a result of the calculation in S43 and from the cryptogram C=(U, V, W) (S644).

[Equation 84]
M=H₂(σ)⊕W (84)

Further, the arithmetic unit 112 calculates rεZ^{q} in Equation 85 from M defined as a result of the calculation in S644 and from σ defined as a result of the calculation in S643 (S645).

[Equation 85]
r=H₃(M,σ) (85)

Further, the arithmetic unit 112 checks, from r defined as a result of the calculation in S645 and from the cryptogram C=(U, V, W), whether a checking formula in Equation 86 is satisfied or not (S646).

[Equation 86]
U=rP (86)

If the checking formula is satisfied, the calculation result M in S644 is output as the message text. If the checking formula is not satisfied, the cryptogram C=(U, V, W) is considered to be an invalid cryptogram and is therefore discarded.

The public key crypto-communication method described in the second embodiment is capable of proving, in the same way as in the case of the first embodiment, security in the sense of IND-ID-CCA (ID-based INDistinguishability under adaptive Chosen Ciphertext Attack), wherein the computational intractability of the Bilinear Diffie-Hellman (BDH) problem is used as the cryptographic assumption. It is the same as, in the case of the first embodiment, proving that public key crypto-communication method has tight security reduction.

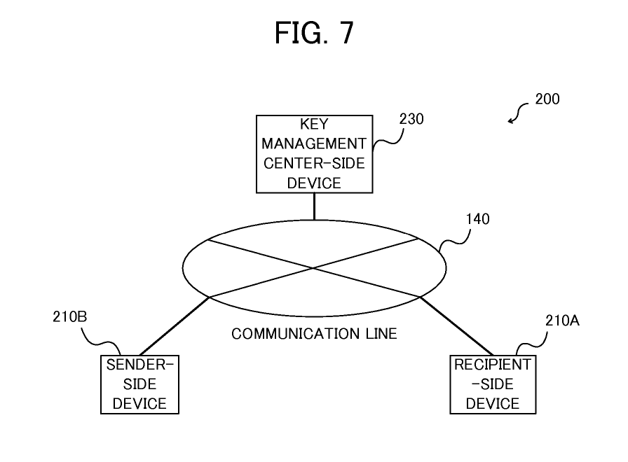

FIG. 7 is a schematic diagram of a communication system 200 common to a third embodiment and a fourth embodiment of the present invention.

As illustrated in FIG. 7, the communication system 200 includes a recipient-side device 210A, a sender-side device 210B and a key management center-side device 230, which are connected to the communication line 140.

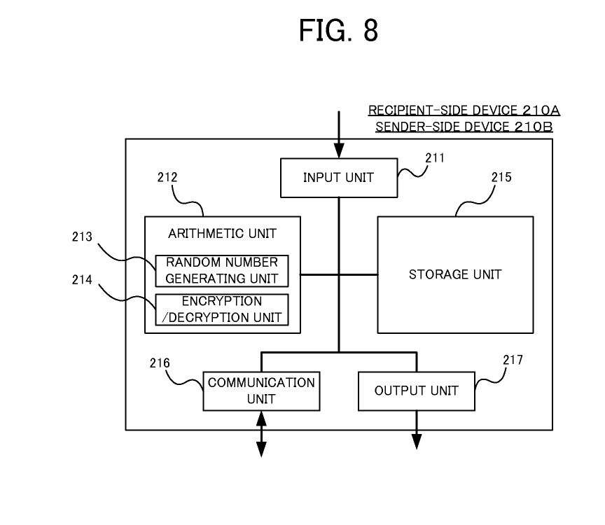

FIG. 8 is a schematic diagram of the recipient-side device 210A and the sender-side device 210B. The recipient-side device 210A and the sender-side device 210B in the second embodiment have the same configuration.

As illustrated in FIG. 8, each of the recipient-side device 210A and the sender-side device 210B includes an input unit 211 which is used to input information, an arithmetic unit 212 which performs a variety of operations including a logical operation, exponentiation, remainder operation, hash function operation and random function operation, and controls the respective units of the recipient-side device 210A or the sender-side device 210B, a storage unit 215, a communication unit 216 performing communications via the communication line 140, and an output unit 217 which outputs the information.

Further, the arithmetic unit 212 has a random number generating unit 213 which generates random numbers, and an encrypting/decrypting unit 214 which executes an encryption/decryption process.

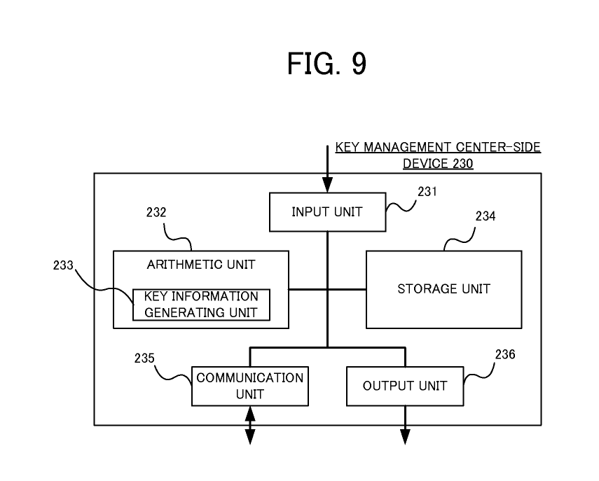

FIG. 9 is a schematic diagram of the key management center-side device 230.

As illustrated in FIG. 9, the key management center-side device 230 has an input unit 231 which is used to input information, an arithmetic unit 232 which performs a variety of operations including a logical operation, exponentiation, remainder operation, hash function operation and random function operation, and controls the respective units of the key management center-side device 230, a storage unit 234, a communication unit 235 performing communications via the communication line 140 with the recipient-side device 210A and the sender-side device 210B, and an output unit 236 which outputs the information.

Further, the arithmetic unit 232 includes a key information generating unit 233 which generates a system parameter, a master key and a private key.

The recipient-side device 210A, sender-side device 210B, and key management center-side device 230 having the above configuration can be realized in such that the CPU 401 executes predetermined programs (program code) loaded into the memory 402 in a general type of computer 400 including, as illustrated in FIG. 4, the CPU 401, the memory 402, the external storage device 403 such as the HDD, the reading device 404 which reads the information from the storage medium 409 having portability as in the case of a CD-ROM and a DVD-ROM, the input device 405 such as a keyboard or a mouse, the output device 406 such as a display, the communication device 407 which communicates with the partner communication device via the communication line 300, and the bus 408 which connects the respective devices to each other. In this case, the memory 402 and the external storage device 403 are utilized for the storage units 215, 234, the communication device 407 is utilized for the communication units 216, 235, the input device 405 and the reading device 404 are employed for the input units 211, 231, and the output device 406 is used for the output units 217, 236.

The predetermined programs (program code) may also be downloaded into the external storage device 403 from the storage medium 409 via the reading device 404 or from the communication line 140 via the communication device 407, and loaded into the memory 402, wherein the CPU 401 may execute the programs. Further, the programs may also be loaded directly into the memory 402 from the storage medium 409 via the reading device 404 or from the communication line 140 via the communication device 407, wherein the CPU 401 may execute the programs.

Note that the programs can be provided as a program product while being stored on the storage medium.

### Third Embodiment

A third embodiment of the present invention will be described.

The third embodiment will exemplify a method by which the user A using the recipient-side device 210A and the user B employing the sender-side device 210B perform the crypto-communications via the communication line 140 by use of key information generated by the key management center-side device 230.

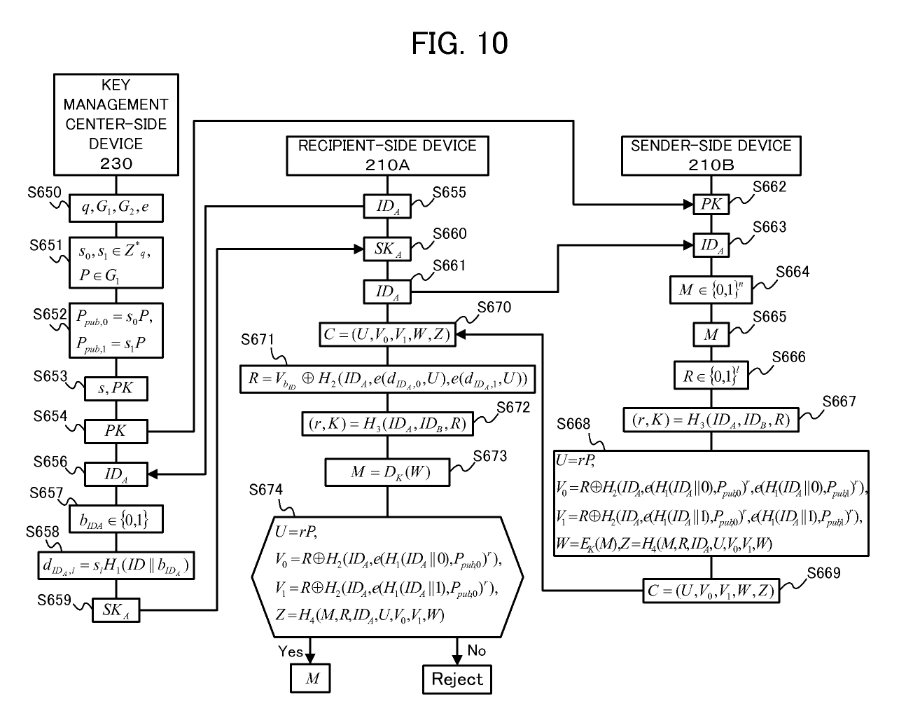

Note that FIG. 10 is an explanatory diagram showing operation procedures in the third embodiment of the present invention.

1. Processes in Key Management Center-Side Device 230

In the key management center-side device 230, the arithmetic unit 232, when accepting a key generating instruction from a manager at a key management center via the input unit 231, generates the prime number q, the additive group G₁ of the order q, the multiplicative group G₂ of the order q, and the bilinear mapping e given from Equation 87 by use of the key information generating unit 233 (S650).

[Equation 87]
e:G₁×G₁→G₂ (87)

Next, the arithmetic unit 232 selects at random s₀, s₁εZ*_{q} and PεG₁ by use of the key information generating unit 233 (S651).

Then, the key information generating unit 233 of the arithmetic unit 232 generates Equation 88 by employing s₀, s₁ and P selected at random (S652).

$$\begin{matrix}[ Equation 88 ] & \\ \begin{matrix}{P}_{pub , 0} = {s}_{0} P , \\ {P}_{pub , 1} = {s}_{1} P\end{matrix} \} & ( 88 )\end{matrix}$$

Subsequently, the arithmetic unit 232 stores both of s=(s₀, s₁) as a master key and PK=(q, G₁, G₂, e, l, m, n, P, P_{pub}, H₁, H₂, H₃, H₄, E, D) as system parameters in the storage unit 234 (S653). Herein, l, m, n represent natural numbers, E represents an encryption function in common key cryptography, D designates a decryption function in the common key cryptography, and H₁, H₂, H₃, H₄ denote hash functions given by Equation 89.

$$\begin{matrix}[ Equation 89 ] & \\ \begin{matrix}{H}_{1} : {\{ 0 , 1 \}}^{*} \to {G}_{1} , {H}_{2} : {\{ 0 , 1 \}}^{*} \times {G}_{2} \times {G}_{2} \to {\{ 0 , 1 \}}^{l} , \\ {H}_{3} : {\{ 0 , 1 \}}^{*} \to {ℤ}_{q} \times {\{ 0 , 1 \}}^{m} , {H}_{4} : {\{ 0 , 1 \}}^{*} \to {\{ 0 , 1 \}}^{l}\end{matrix} \} & ( 89 )\end{matrix}$$

Next, the arithmetic unit 232 outputs the system parameter PK generated in S653 from the output unit 236, or alternatively transmits PK to the sender-side device 210B via the communication line 140 from the communication unit 235 (S654). Note that if the system parameter PK is outputted from the output unit 236, the key management center notifies the user B of the system parameter PK by post, or the like.

2. Processes in Recipient-Side Device 210A

In the recipient-side device 210A, the arithmetic unit 212 stores individual information ID_{A} of the user A, which is accepted from the user A via the input unit 211, in the storage unit 215, and transmits ID_{A} to the key management center-side device 230 from the communication unit 216 via the communication line 140 (S655). Note that the user A may notify the key management center of the individual information ID_{A} of the user A together with an address of the recipient-side device 210A by post, or the like.

3. Processes in Key Management Center-Side Device 230

In the key management center-side device 230, the arithmetic unit 232 stores the individual information ID_{A} of the user A, which has been received by the communication unit 235 via the communication line 140 from the recipient-side device 210A or input together with the address of the recipient-side device 210A via the input unit 231, in the storage unit 234, in a way that associates the individual information ID_{A} with the address of the recipient-side device 210A (S656).

Then, the arithmetic unit 232 selects at random b_{IDA}ε{0,1} by using the key information generating unit 233 (S657).

Next, the arithmetic unit 232 calculates Equation 90 from the master key s and the individual information ID_{A} of the user A which are stored in the storage unit 234 by use of the key information generating unit 233 (S658).

[Equation 90]
d_{ID}_{_{A,}}ᵢ=sᵢH₁(ID∥b_{ID}_{_{A}}) (i=0,1) (90)

Then, the arithmetic unit 232 outputs SK_{A}=(b_{IDA}, d_{IDA,0}, d_{IDA,1}) as a private key of the user A from the output unit 236, or transmits SK_{A}=(b_{IDA}, d_{IDA,0}, d_{IDA,1}) to the recipient-side device 210A from the communication unit 235 via the communication line 140 by a secure method (e.g., through the crypto-communications using the encryption key shared between the key management center-side device 230 and the recipient-side device 210A) (S659). Note that if the private key SK_{A} is output from the output unit 236, the key management center notifies the user A of the private key SK_{A} by a secure method such as posting an IC card.

4. Processes in Recipient-Side Device 210A

In the recipient-side device 210A, the arithmetic unit 212 stores the private key SK_{A} received by the communication unit 216 via the communication line 140 from the key management center-side device 230 or input via the input unit 211 in the storage unit 215 (S660).

Further, the arithmetic unit 212, when receiving an instruction of transmitting the individual information ID_{A} of the user A via the input unit 211 from the user A, transmits the individual information ID_{A} of the user A from the communication unit 216 via the communication line 140 (S661).

5. Processes in Sender-Side Device 210B

In the sender-side device 210B, the arithmetic unit 212 stores the system parameter PK received by the communication unit 216 from the key management center-side device 230 via the communication line 140 or input via the input unit 211 in the storage unit 215 (S662).

Further, in the sender-side device 210B, the arithmetic unit 212 stores the individual information ID_{A} of the user A received by the communication unit 216 from the recipient-side device 210A via the communication line 140 or input via the input unit 211 in the storage unit 215 (S663).

Next, the user B inputs the message text Mε{0,1}ⁿ (n is a positive integer) via the input unit 211 (S664).

Upon inputting the message text M, the arithmetic unit 212 stores the input message text M in the storage unit 215 (S665).

Then, the arithmetic unit 212 selects at random Rε{0,1}^{l} by use of the random number generating unit 213 (S666).

Next, the arithmetic unit 212 calculates rεZ_{q} and Kε{0, 1}^{m}, which are given by Equation 91, in a way that employs R selected in S666, and the message text M, the system parameter PK, the individual information ID_{A} of the user A, and individual information ID_{B} of the user B, which are stored in the storage unit 215 (S667)

[Equation 91]
(r,K)=H₃(ID_{A},ID_{B},R) (91)

Further, the arithmetic unit 212 calculates Equation 92 by use of r and K calculated in S667 (S668).

$$\begin{matrix}[ Equation 92 ] & \\ \begin{matrix}U = rP , {V}_{0} = R ⊕ {H}_{2} ( {ID}_{A} , e ( {{H}_{1} ( {ID}_{A} ‖ 0 ) , {P}_{pub , 0} )}^{r} , \\ e ( {{H}_{1} ( {ID}_{A} ‖ 0 ) , {P}_{pub , 1} )}^{r} ) , \\ {V}_{1} = R ⊕ {H}_{2} ( {ID}_{A} , e ( {{H}_{1} ( {ID}_{A} ‖ 1 ) , {P}_{pub , 0} )}^{r} , e ( {{H}_{1} ( {ID}_{A} ‖ 1 ) , {P}_{pub , 1} )}^{r} ) , \\ W = {E}_{K} ( M ) , Z = {H}_{4} ( M , R , {ID}_{A} , U , {V}_{0} , {V}_{1} , W )\end{matrix} \} & ( 92 )\end{matrix}$$

Then, the arithmetic unit 212 outputs a cryptogram C=(U, V₀, V₁, W, Z) generated in S668 from the output unit 217, or transmits the cryptogram C to the recipient-side device 210A from the communication unit 216 via the communication line 140 (S669). Note that if the cryptogram is outputted from the output unit 217, the user B notifies the user A of the cryptogram C by post, or the like.

6. Processes in Recipient-Side Device 210A

The arithmetic unit 212 of the recipient-side device 210A stores the cryptogram C received by the communication unit 216 from the sender-side device 210B via the communication line 140 or input by the user A via the input unit 211 in the storage unit 215 (S670).

Next, the arithmetic unit 212, by use of the encryption/decryption unit 214, calculates Rε{0, 1}^{l} in Equation 93 from the individual information ID_{A} of the user A and the private key SK_{A} stored in the storage unit 215 with respect to the cryptogram C stored in the storage unit 215 (S671).

[Equation 93]
R=V_{b}_{_{ID}}⊕H₂(ID_{A},e(d_{ID}_{_{A,}}₀,U),e(d_{ID}_{_{A,}}₁,U)) (93)

Moreover, the arithmetic unit 212 calculates rεZ_{q} and Kε{0, 1}^{m} from Equation 94 by employing R calculated in S671, and the individual information ID_{A} of the user A and the individual information ID_{B} of the user B, which are stored in the storage unit 215 (S672).

[Equation 94]
(r,K)=H₃(ID_{A},ID_{B},R) (94)

Next, the arithmetic unit 212 calculates Mε{0, 1}ⁿ from Equation 95 by use of K calculated in S672 (S673).

[Equation 95]
M=D_{K}(W) (95)

Then, the arithmetic unit 212 checks, from R calculated in S671, r calculated in S672 and M calculated in S673, and the cryptogram C, whether a checking formula in Equation 96 is satisfied or not (S674).

$$\begin{matrix}[ Equation 96 ] & \\ \begin{matrix}U = rP , {V}_{0} = R ⊕ {H}_{2} ( {ID}_{A} , e ( {{H}_{1} ( {ID}_{A} ‖ 0 ) , {P}_{pub} )}^{r} ) , \\ {V}_{1} = R ⊕ {H}_{2} ( {ID}_{A} , e ( {{H}_{1} ( {ID}_{A} ‖ 1 ) , {P}_{pub} )}^{r} ) , \\ Z = {H}_{4} ( M , R , {ID}_{A} , U , {V}_{0} , {V}_{1} , W )\end{matrix} \} & ( 96 )\end{matrix}$$

If this checking formula is satisfied, the calculation result M given in S673 is outputted as a message text. If this checking formula is not satisfied, the cryptogram C=(U, V₀, V₁, W, Z) is considered as an invalid cryptogram and is therefore discarded.

The ID-based crypto-communication method described in the third embodiment of the present invention is capable of proving, in the same way as described in Non-Patent Document 4, security in the sense of indistinguishability for ID-based encryptions under adaptive chosen ciphertext attack (IND-ID-CCA), in which the computational intractability of a List Bilinear Diffie-Hellman (LBDH) problem is the cryptographic assumption.

Herein, supposing that there exists an algorithm capable of breaking the public key encryption system in the third embodiment of the present invention with an advantage ε in the sense of IND-ID-CCA, it is shown that an algorithm capable of solving the LBDH problem substantially with the advantage ε by use of the former algorithm, can be built up. It is recognized from this point that the ID-based encryption system according to the third embodiment of the present invention has tight security reduction.

Further, the system according to the third embodiment of the present invention has, in the encryption process, one less calculation for the bilinear mapping, which requires a large quantity of calculations, than the system described in Non-Patent Document 4, and can therefore realize a faster encryption process. In the crypto-communication method in the third embodiment of the present invention, the cryptogram can be generated and the message can be decrypted with the same procedures as those described above by changing the input value to W defined as a part of the cryptogram, to another parameter utilized in the present system.

The encryption system in the third embodiment of the present invention involves using the plurality of hash functions; however, it is possible to organize such a plurality of functions as to obtain different output values by previously setting plural values serving as seeds, separately from the input values, with respect to a single hash function. The hash function can be also given by this type of method.

### Fourth Embodiment

A fourth embodiment of the present invention will be described.

The fourth embodiment of the present invention deals with a system which is longer in key length than that of the third embodiment of the present invention, but the system is superior in terms of high-speed capability of the encryption process and the decryption process, compared to that of the third embodiment of the present invention.

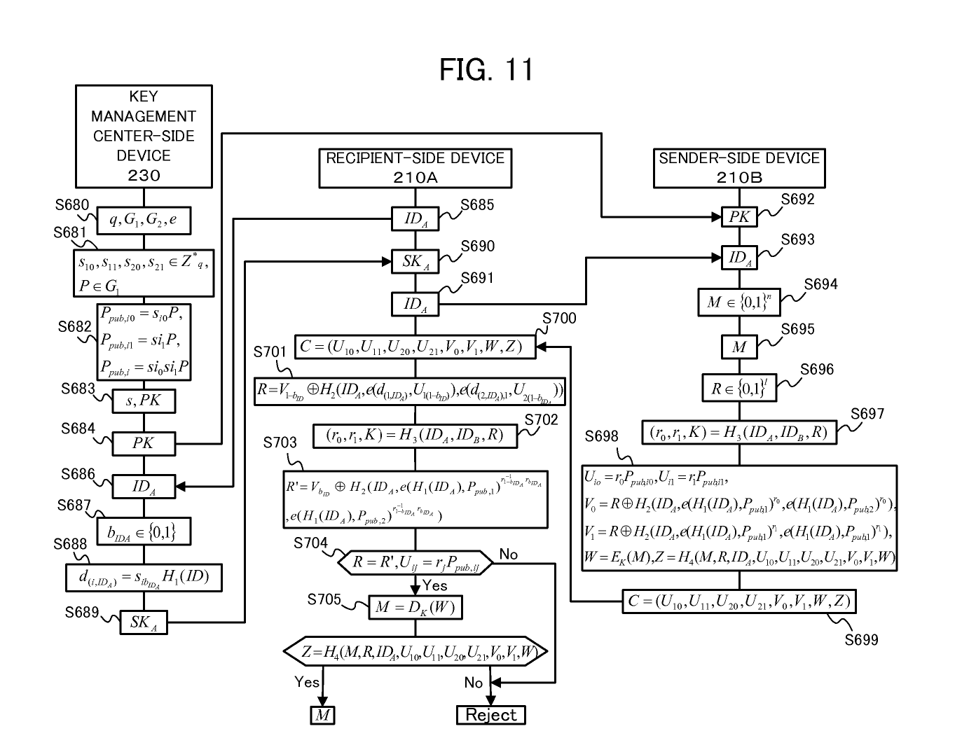

Note that FIG. 11 is an explanatory diagram showing operation procedures in the fourth embodiment of the present invention.

1. Processes in Key Management Center-Side Device 230

In the key management center-side device 230, the arithmetic unit 232, when accepting a key generating instruction from a manager at a key management center via the input unit 231, generates the prime number q, the additive group G₁ of the order q, the multiplicative group G₂ of the order q, and the bilinear mapping e given from Equation 97 by use of the key information generating unit 233 (S680).

[Equation 97]
e:G₁×G₁→G₂ (97)

Next, the arithmetic unit 232 selects at random s₁₀, s₁₁, s₂₀, s₂₁εZ*_{q} and PεG₁ by use of the key information generating unit 233 (S681).

Then, the key information generating unit 233 of the arithmetic unit 232 generates Equation 98 by employing s₁₀, s₁₁, s₂₀, s₂₁ and P selected at random (S682).

$$\begin{matrix}[ Equation 98 ] & \\ \begin{matrix}{P}_{pub , i 0} = {s}_{i 0} P , \\ {P}_{pub , i 1} = {s}_{i 1} P , \\ {P}_{pub , i} = {s}_{i 0} {s}_{i 1} P ( i = 1 , 2 )\end{matrix} \} & ( 98 )\end{matrix}$$

Subsequently, the arithmetic unit 232 stores both of s=(s₁₀, s₁₁, s₂₀, s₂₁) as a master key and PK=(q, G₁, G₂, e, l, m, n, P, P_{pub,10}, P_{pub,11}, P_{pub,1}, P_{pub,20}, P_{pub,21}, P_{pub,2}, H₁, H₂, H₃, H₄, E, D) as a system parameter in the storage unit 234 (S683). Herein, l, m, n represent natural numbers, E represents an encryption function in common key cryptography, D designates a decryption function in the common key cryptography, and H₁, H₂, H₃, H₄ denote hash functions given by Equation 99.

$$\begin{matrix}[ Equation 99 ] & \\ \begin{matrix}{H}_{1} : {\{ 0 , 1 \}}^{*} \to {G}_{1} , {H}_{2} : {G}_{2} \times {G}_{2} \to {\{ 0 , 1 \}}^{l} , \\ {H}_{3} : {\{ 0 , 1 \}}^{*} \to {ℤ}_{q} \times {ℤ}_{q} \times {\{ 0 , 1 \}}^{m} , {H}_{4} : {\{ 0 , 1 \}}^{*} \to {\{ 0 , 1 \}}^{l}\end{matrix} \} & ( 99 )\end{matrix}$$

Next, the arithmetic unit 232 outputs the system parameter PK generated in S683 from the output unit 236, or alternatively transmits PK to the sender-side device 210B via the communication line 140 from the communication unit 235 (S684). Note that if the system parameter PK is outputted from the output unit 236, the key management center notifies the user B of the system parameter PK by post, or the like.

2. Processes in Recipient-Side Device 210A

In the recipient-side device 210A, the arithmetic unit 212 stores individual information ID_{A} of the user A, which is accepted from the user A via the input unit 211, in the storage unit 215, and transmits ID_{A} to the key management center-side device 230 from the communication unit 216 via the communication line 140 (S685). Note that the user A may notify the key management center of the individual information ID_{A} of the user A together with an address of the recipient-side device 210A by post, or the like.

3. Processes in Key Management Center-Side Device 230

In the key management center-side device 230, the arithmetic unit 232 stores the individual information ID_{A} of the user A, which has been received by the communication unit 235 via the communication line 140 from the recipient-side device 210A or input together with the address of the recipient-side device 210A via the input unit 231 in the storage unit 234, in a way that associates the individual information ID_{A} with the address of the recipient-side device 210A (S686).

Then, the arithmetic unit 232 selects at random b_{IDA}ε{0,1} by using the key information generating unit 233 (S687).

Next, the arithmetic unit 232 calculates Equation 100 from the master key s and the individual information ID_{A} of the user A which are stored in the storage unit 234 by use of the key information generating unit 233 (S688).

$$[ Equation 100 ]$$

$${d}_{( i , {ID}_{A} )} = {{s}_{ib}}_{{ID}_{A}} {H}_{1} ( ID ) ( i = 1 , 2 ) \qquad ( 100 )$$

Herein, ε is set in advance by a string unique to the system.

Further, the arithmetic unit 232 outputs SK_{A}=(b_{IDA}, d_{(1, IDA)}, d_{(2, IDA)}) as a private key of the user A from the output unit 236, or transmits SK_{A}=(b_{IDA}, d_{(1, IDA)}, d_{(2, IDA)}) to the recipient-side device 210A from the communication unit 235 via the communication line 140 by a secure method (e.g., through the crypto-communications using the encryption key shared between the key management center-side device 230 and the recipient-side device 210A) (S689). Note that if the private key SK_{A} is outputted from the output unit 236, the key management center notifies the user A of the private key SK_{A} by a secure method such as packing and posting an IC card.

4. Processes in Recipient-Side Device 210A

In the recipient-side device 210A, the arithmetic unit 212 stores the private key SK_{A} received by the communication unit 216 via the communication line 140 from the key management center-side device 230 or input via the input unit 211 in the storage unit 215 (S690).

Further, the arithmetic unit 212, when receiving an instruction of transmitting the individual information ID_{A} of the user A via the input unit 211 from the user A, transmits the individual information ID_{A} of the user A from the communication unit 216 via the communication line 140 (S691).

5. Processes in Sender-Side Device 210B

In the sender-side device 210B, the arithmetic unit 212 stores the system parameter PK received by the communication unit 216 from the key management center-side device 230 via the communication line 140 or input via the input unit 211, in the storage unit 215 (S692).

Further, in the sender-side device 210B, the arithmetic unit 212 stores the individual information ID_{A} of the user A received by the communication unit 216 from the recipient-side device 210A via the communication line 140 or input via the input unit 211, in the storage unit 215 (S693).

Next, the user B inputs the message text Mε{0, 1}ⁿ (n is the positive integer) via the input unit 211 (S694).

Upon input of the message text M, the arithmetic unit 212 stores the input message text M in the storage unit 215 (S695).

Then, the arithmetic unit 212 selects at random Rε{0, 1}^{l} by use of the random number generating unit 213 (S696).

Next, the arithmetic unit 212 calculates r₀, r₁εZ_{q} and Kε{0, 1}^{m}, which are given by Equation 101, in a way that employs R selected in S696, and the message text M, the system parameter PK, the individual information ID_{A} of the user A, and individual information ID_{B} of the user B, which are stored in the storage unit 215 (S697).

[Equation 101]
(r₀,r₁,K)=H₃(ID_{A},ID_{B},R) (101)

Further, the arithmetic unit 212 calculates Equation 102 by use of r₀, r₁ and K calculated in S697 (S698).

$$\begin{matrix}[ Equation 102 ] & \\ \begin{matrix}{U}_{i 0} = {r}_{0} {P}_{pub , i 0} , {U}_{i 1} = {r}_{1} {P}_{pub , i 1} ( i = 1 , 2 ) \\ {V}_{0} = R ⊕ {H}_{2} ( {ID}_{A} , {e ( {H}_{1} ( {ID}_{A} ) , {P}_{pub , 1} )}^{{r}_{0}} , {e ( {H}_{1} ( {ID}_{A} ) , {P}_{pub , 2} )}^{{r}_{0}} ) \\ {V}_{1} = R ⊕ {H}_{2} ( {ID}_{A} , {e ( {H}_{1} ( {ID}_{A} ) , {P}_{pub , 1} )}^{{r}_{1}} , {e ( {H}_{1} ( {ID}_{A} ) , {P}_{pub , 2} )}^{{r}_{1}} ) \\ W = {E}_{K} ( M ) , Z = {H}_{4} ( M , R , {ID}_{A} , {U}_{10} , {U}_{11} , \\ {U}_{20} , {U}_{21} , {V}_{0} , {V}_{1} , W )\end{matrix} \} & ( 102 )\end{matrix}$$

Then, the arithmetic unit 212 outputs a cryptogram C=(U₁₀, U₁₁, U₂₀, U₂₁, V₀, V₁, W, Z) generated in S698 from the output unit 217 or transmits this cryptogram C to the recipient-side device 210A from the communication unit 216 via the communication line 140 (S699). Note that if the cryptogram is output from the output unit 217, the user B notifies the user A of the cryptogram C by post, or the like.

6. Processes in Recipient-Side Device 210A

The arithmetic unit 212 of the recipient-side device 210A stores the cryptogram C received by the communication unit 216 from the sender-side device 210B via the communication line 140 or input by the user A via the input unit 211 in the storage unit 215 (S700).

Next, the arithmetic unit 212, by use of the encryption/decryption unit 214, calculates Rε{0,1}^{l} in Equation 103 from the individual information ID_{A} of the user A and the private key SK_{A} stored in the storage unit 215 with respect to the cryptogram C stored in the storage unit 215 (S701).

$$[ Equation 103 ]$$

$$R = {V}_{1 - {b}_{ID}} ⊕ {H}_{2} ( {ID}_{A} , e ( {d}_{( 1 , {ID}_{A} )} , {U}_{1 , ( 1 - {b}_{I D} )} ) , e ( {d}_{( 2 , {ID}_{A} )} , {U}_{2 , ( 1 - {b}_{I {D}_{A}} )} ) ) \qquad ( 103 )$$

Moreover, the arithmetic unit 212 calculates r₀, r₁εZ_{q} and Kε{0,1}^{m} from Equation 104 by employing R calculated in S701, and the individual information ID_{A} of the user A and the individual information ID_{B} of the user B, which are stored in the storage unit 215 (S702).

[Equation 104]
(r₀,r₁,K)=H₃(ID_{A},ID_{B},R) (104)

Next, the arithmetic unit 212 calculates R′ε{0, 1}^{l} from Equation 105 (S703).

$$\begin{matrix}[ Equation 105 ] & \\ {R}^{′} = {V}_{{b}_{ID}} ⊕ {H}_{2} ( \begin{matrix}I {D}_{A} , {e ( {H}_{1} ( I {D}_{A} ) , {P}_{pub , 1} )}^{{r}_{1 - {b}_{I {D}_{A}}}^{- 1} {r}_{{b}_{I {D}_{A}}}} , \\ {e ( {H}_{1} ( I {D}_{A} ) , {P}_{pub , 2} )}^{{r}_{1 - {b}_{I {D}_{A}}}^{- 1} {r}_{{b}_{I {D}_{A}}}}\end{matrix} ) & ( 105 )\end{matrix}$$

Then, the arithmetic unit 212 checks, from R calculated in S701, r calculated in S702, R′ calculated in S703, and the cryptogram C, whether a checking formula in Equation 106 is satisfied or not (S704).

[Equation 106]
R=R′,Uᵢⱼ=rⱼP_{pub,ij}(1≦i≦2,0≦j≦1) (106)

If this checking formula is satisfied, the arithmetic unit 212 calculates Equation 107 (S705).

[Equation 107]
M=D_{K}(W) (107)

Further, the arithmetic unit 212 checks whether a checking formula in Equation 108 is satisfied or not (S706).

[Equation 108]
Z=H₄(M,R,ID_{A},U₁₀,U₁₁,U₂₀,U₂₁,V₀,V₁,W) (108)

If this checking formula is satisfied, the calculation result M given in S673 is outputted as the message text. If this checking formula is not satisfied, the cryptogram C=(U₁₀, U₁₁, U₂₀, U₂₁, V₀, V₁, W, Z) is considered as an invalid cryptogram and is therefore discarded.

The encryption method according to the fourth embodiment of the present invention is capable of proving, in the same way as the way described in Non-Patent Document 1 and Non-Patent Document 4, security in the sense of IND-ID-CCA, in which the computational intractability of a Bilinear Diffie-Hellman (BDH) problem is the cryptographic assumption.

Herein, supposing that there exists an algorithm capable of breaking the public key encryption system in the third embodiment of the present invention with an advantage ε in the sense of IND-ID-CCA, it is shown that an algorithm capable of solving the BDH problem substantially with the advantage ε by use of the former algorithm can be built up. It is recognized from this point that the ID-based encryption system according to the third embodiment of the present invention has tight security reduction.

The ID-based encryption method according to the fourth embodiment of the present invention has less calculations using the bilinear mapping, which requires a large quantity of calculations, and therefore enables the encryption and the decryption to be done with high efficiency.

In the crypto-communication method in the fourth embodiment of the present invention, the cryptogram can be generated and the message can be decrypted with the same procedures as those described above by changing the input value to W defined as a part of the cryptogram, to another parameter utilized in the present system.

Further, the encryption system in the third embodiment of the present invention involves using the plurality of hash functions; however, it is possible to organize such a plurality of functions as to obtain different output values by previously setting plural values serving as seeds, separately from the input values, with respect to a single hash function. The hash function can be also given by this type of method.

The fourth embodiment discussed above was exemplified in a general mode in which the users perform the crypto-communications by using the individual devices, but can be specifically applied to a variety of systems. For example, in an electronic shopping system, the user who is the sender is a consumer, the user who is the recipient is a retail shop, and the user-side device is a computer such as a personal computer (PC). Moreover, in an electronic mail system, the respective devices are computers such as PCs. In addition, the schemes can be applied to a variety of systems which employ the conventional public key cryptography and ID-based cryptography.

Further, the respective calculations in the fourth embodiment discussed above have been described as those performed by the CPU executing the programs in memory. However, without being limited to the programs, any one of the calculations may be an arithmetic device implemented as hardware, and this arithmetic device may transmit and receive the data to and from other arithmetic devices and the CPU.

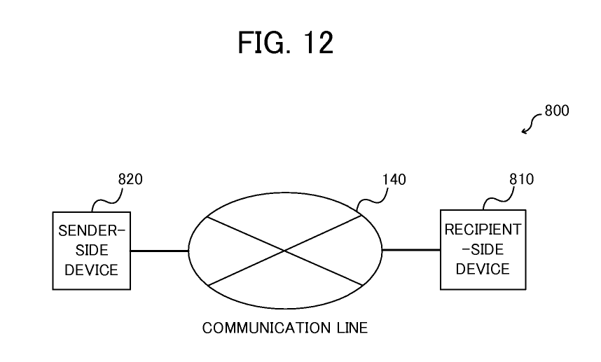

FIG. 12 is a schematic diagram of a communication system 800 common to a fifth embodiment, a sixth embodiment, a seventh embodiment, and an eighth embodiment of the present invention.

As illustrated in FIG. 12, the communication system 800 includes a recipient-side device 810 and a sender-side device 820, which are connected to the communication line 140.

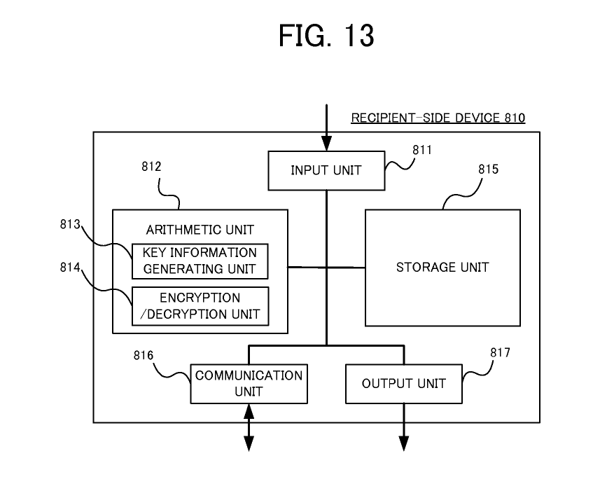

FIG. 13 is a schematic diagram of the recipient-side device 810.

As shown in FIG. 12, the recipient-side device 810 includes an input unit 811 which is used to input information, an arithmetic unit 812 which performs a variety of operations including a logical operation, exponentiation, remainder operation, hash function operation, and random function operation, and controls the respective units of the recipient-side device 810, a storage unit 815, a communication unit 816 which communicates with the sender-side device 820 via the communication line 140, and an output unit 817 which outputs the information.

Further, the arithmetic unit 812 has a key information generating unit 813 which generates the encryption key and the decryption key, and an encryption/decryption unit 814 which executes the encryption/decryption process.

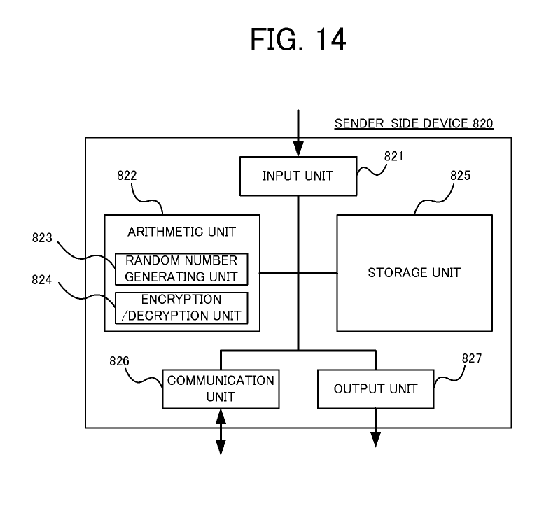

FIG. 14 is a schematic diagram of the sender-side device 820.

As illustrated in FIG. 14, the sender-side device 820 has an input unit 821 which is used to input information, an arithmetic unit 822 which performs a variety of operations including logical operation, exponentiation, remainder operation, and hash function operation, and controls the respective units of the sender-side device 820, a storage unit 825, a communication unit 826 which communicates with the recipient-side device 810 via the communication line 140, and an output unit 827 which outputs the information.

Moreover, the arithmetic unit 822 has a random number generating unit 823 which generates the random numbers, and an encryption/decryption unit 824 which executes an encryption/decryption process.

The recipient-side device 810 and sender-side device 820 having the above configuration can be realized such that the CPU 401 executes predetermined programs (program code) loaded into the memory 402 in a general type of computer 400 including, as illustrated in FIG. 4, the CPU 401, the memory 402, the external storage device 403 such as a HDD, the reading device 404 which reads information from the storage medium 409 having portability such as a CD-ROM or a DVD-ROM, the input device 405 such as a keyboard or a mouse, the output device 406 such as a display, the communication device 407 which communicates with the partner communication device via the communication line 300, and the bus 408 which connects the respective devices to each other. In this case, the memory 402 and the external storage device 403 are utilized for the storage units 815 and 825, the communication device 407 is utilized for the communication units 816 and 826, the input device 405 and the reading device 404 are employed for the input units 811 and 821, and the output device 406 is used for the output units 817 and 827.

The predetermined programs (program code) may also be downloaded into the external storage device 403 from the storage medium 409 via the reading device 404 or from the communication line 140 via the communication device 407, and loaded into the memory 402, whereby the CPU 401 may execute the programs. Further, the programs may also be loaded directly into the memory 402 from the storage medium 409 via the reading device 404 or from the communication line 140 via the communication device 407, whereby the CPU 401 may execute the programs.

Note that the programs can be provided as a program product while being stored on the storage medium.

### Fifth Embodiment

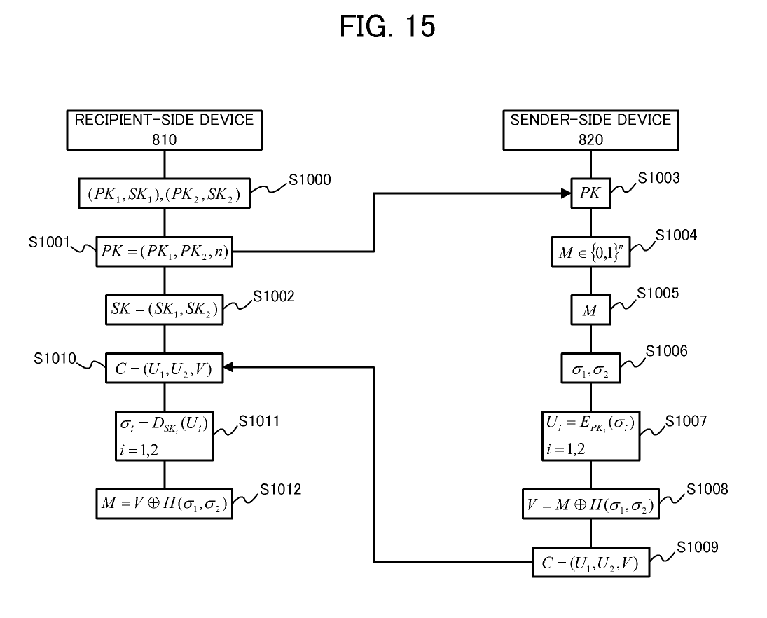

FIG. 15 is an explanatory diagram showing operation procedures in a fifth embodiment of the present invention.

The fifth embodiment of the present invention relates to the encryption system in which the recipient-side device 810 and the sender-side device 820 perform the crypto-communications via the communication line 140, and will exemplify a case of building up another encryption system (having higher security) while making the use of the encryption method in the existing encryption system on the assumption that the crypto-communication system using the public key encryption (which will hereinafter be referred to as encryption system PKE) already exist.

It is to be noted that the recipient-side device 810 and the sender-side device 820 in the fifth embodiment of the present invention support a certain common encryption system.

1. Processes in Recipient-Side Device 810

In the recipient-side device 810, the arithmetic unit 812, when accepting a key generating instruction from the user via the input unit 811, executes twice a step for generating keys according to the encryption system PKE by employing the key information generating unit 813, thereby generating two pairs of keys (PK₁, SK₁,), (PK₂, SK₂) (S1000).

Next, the recipient-side device 810, upon accepting the instruction from the user via the input unit 811, discloses (PK in) Equation 109 (where n is non-negative integer) as a new public key via the communication unit 816 or the output unit 817 (S1001), and stores (SK in) Equation 110 as a user's secret key of the recipient-side device 810 in the storage unit 815 (S1002).

[Equation 109]
PK=(PK₁,PK₂,n) (109)
[Equation 110]
SK=(SK₁,SK₂) (110)

2. Processes in Sender-Side Device 820

The arithmetic unit 822 of the sender-side device 820 acquires the public key PK open to the public by the recipient-side device 810 via the communication unit 826 or the input unit 821, and stores the public key PK in the storage unit 825 (S1003).

Next, the user of the sender-side device 820 inputs, via the input unit 821, a message text Mε{0, 1}^{m}, m=n (n is a non-negative integer open to the public as a public key) (S1004).

When the message text M is input, the arithmetic unit 822 stores the input message text M in the storage unit 825 (S1005).

Next, the arithmetic unit 822, by use of the random number generating unit 823, selects at random σ₁, σ₂ contained in the message space of the encryption system PKE, with respect to the message text M (S1006).

Then, the arithmetic unit 822 calculates Equation 111 by use of the encryption/decryption unit 824 (S1007).

[Equation 111]
Uᵢ=E_{PK}_{ᵢ}(σᵢ) (i=1,2) (111)

Herein, E_{PK} (x) represents a result into which a message text x is encrypted according to the encryption system PKE by using the public key PK.

Further, the arithmetic unit 822 calculates Equation 112 by use of the encryption/decryption unit 824 (S1008).

[Equation 112]
V=M⊕H(σ₁,σ₂) (112)

Then, the arithmetic unit 822 of the sender-side device 820 outputs the cryptogram C=(U₁, U₂, V) generated in step S1008 from the output unit 827, or transmits the cryptogram C to the recipient-side device 810 via the communication line 140 from the communication unit 826 (S1009). Note that when the cryptogram C is output from the output unit 827, the user of the sender-side device 820 notifies the user of the recipient-side device 810, of the cryptogram C by post, or the like.

3. Processes in Recipient-Side Device 810

The arithmetic unit 812 of the recipient-side device 810 stores the cryptogram C received by the communication unit 816 via the communication line 140 from the sender-side device 820 or input by the user of the recipient-side device 810 via the input unit 811 in the storage unit 815 (S1010). Note that the arithmetic processing unit 812, if the cryptogram C=(U₁, U₂, V) is not contained in a predetermined cryptogram space determined according to the encryption system, rejects this cryptogram as an invalid cryptogram.

Next, the arithmetic unit 812 calculates Equation 113 by using the encryption/decryption unit 814 (S1011).

[Equation 113]
σᵢ=D_{SK}_{ᵢ}(Uᵢ) (i=1,2) (113)

Herein, D_{SK} (y) represents a result of decrypting a cryptogram y by using the secret key SK in the encryption system PKE.

Then, the arithmetic unit 812 decrypts the message M by calculating Equation 114 with respect to the cryptogram C stored in the storage unit 815 by using the encryption/decryption unit 814 (S1012).

[Equation 114]
M=V⊕H(σ₁,σ₂) (114)

The method according to the fifth embodiment of the present invention enables building up the new encryption system without depending on the group defined by the existing encryption systems. Further, the fifth embodiment of the present invention has exemplified the case of building up another encryption system while utilizing the encryption method in the existing encryption system, and similarly enables configuring a new encryption system by providing the encryption system as a basis even when the existing encryption system does not exist.

### Sixth Embodiment

Next, a sixth embodiment of the present invention will be described. The sixth embodiment of the present invention is a modified example of the fifth embodiment of the present invention. It should be noted that the sixth embodiment of the present invention provides the encryption system exhibiting higher security than the fifth embodiment of the present invention.

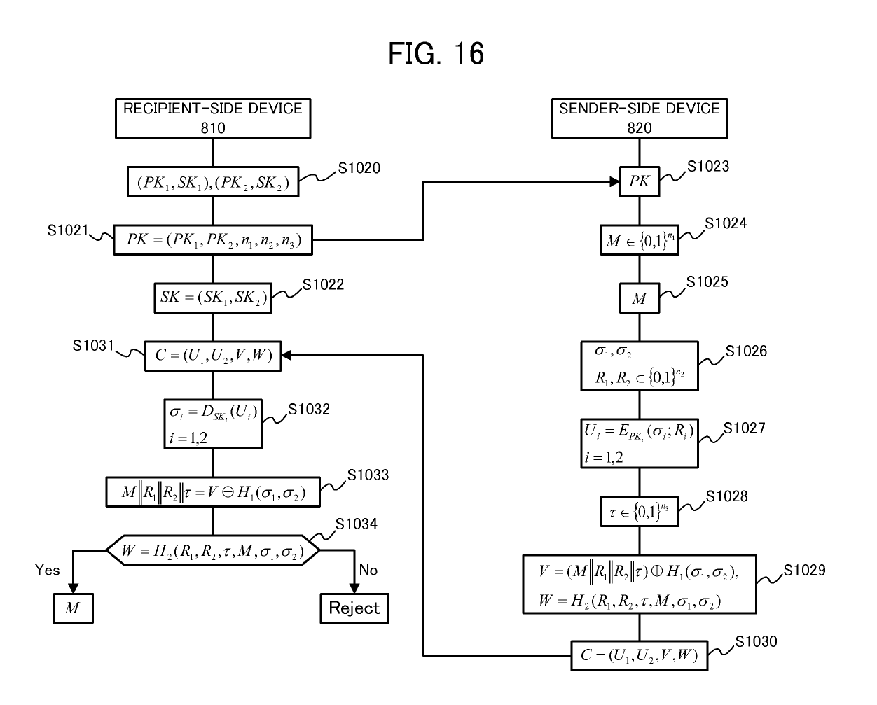

FIG. 16 is an explanatory diagram showing operation procedures in the sixth embodiment of the present invention.

1. Processes in Recipient-Side Device 810

In the recipient-side device 810, the arithmetic unit 812, when accepting a key generating instruction from the user via the input unit 811, executes twice a step of generating keys according to the encryption system PKE by employing the key information generating unit 813, thereby generating two pairs of keys (PK₁, SK₁), (PK₂, SK₂) (S1020).

Next, the recipient-side device 810, upon accepting the instruction from the user via the input unit 811, discloses (PK in) Equation 115 (where n₁, n₂, n₃ are non-negative integers) as a new public key via the communication unit 816 or the output unit 817 (S1021), and stores (SK in) Equation 116 as a user's secret key of the recipient-side device 810, in the storage unit 815 (S1022).

[Equation 115]
PK=(PK₁,PK₂,n₁,n₂,n₃) (115)
[Equation 116]
SK=(SK₁,SK₂) (116)

2. Processes in Sender-Side Device 820

The arithmetic unit 822 of the sender-side device 820 acquires the public key PK open to the public by the recipient-side device 810 via the communication unit 826 or the input unit 821, and stores the public key PK in the storage unit 825 (S1023).

Next, the user of the sender-side device 820 inputs, via the input unit 821, a message text Mε{0, 1}^{m}, m=n₁ (n₁ is a non-negative integer open to the public as a public key) (S1024).

When the message text M is input, the arithmetic unit 822 stores the input message text M in the storage unit 825 (S1025).

Next, the arithmetic unit 822, by use of the random number generating unit 823, selects at random σ₁, σ₂ contained in the message space of the encryption system PKE with respect to the message text M, and further selects at random R₁, R₂ε{0,1}^{m}, m=n₂ (n₂ is a non-negative integer open to the public as a public key) (S1026).

Then, the arithmetic unit 822 calculates Equation 117 by use of the encryption/decryption unit 824 (S1027).

[Equation 117]
Uᵢ=E_{PK}_{ᵢ}(σᵢ;Rᵢ) (i=1,2) (117)

Herein, E_{PK} (x;R) represents a result into which a message text x is encrypted according to the encryption system PKE by using the public key PK in a way that employs a random number R as with a coin toss in a probabilistic cryptosystem. That is, the cryptogram changes depending on the random number R.

Next, the arithmetic unit 822 selects τε{0,1}^{m}, m=n₃ (n₃ is a non-negative integer open to the public as a public key) at random by employing the random number generating unit 823 (S1028), and further calculates Equation 118 using the encryption/decryption unit 824 (S1029).

$$\begin{matrix}[ Equation 118 ] & \\ \begin{matrix}V = ( M ‖ {R}_{1} ‖ {R}_{2} ‖ τ ) ⊕ {H}_{1} ( {σ}_{1} , {σ}_{2} ) \\ W = {H}_{2} ( {R}_{1} , {R}_{2} , τ , M , {σ}_{1} , {σ}_{2} )\end{matrix} \} & ( 118 )\end{matrix}$$

Then, the arithmetic unit 822 of the sender-side device 820 outputs the cryptogram C=(U₁, U₂, V, W) generated in step S1029 from the output unit 827, or transmits the cryptogram C to the recipient-side device 810 via the communication line 140 from the communication unit 826 (S1030). Note that when the cryptogram C is output from the output unit 827, the user of the sender-side device 820 notifies the user of the recipient-side device 810, of the cryptogram C by post, or the like.

3. Processes in Recipient-Side Device 810

The arithmetic unit 812 of the recipient-side device 810 stores the cryptogram C received by the communication unit 816 via the communication line 140 from the sender-side device 820 or input by the user of the recipient-side device 810 via the input unit 811 in the storage unit 815 (S1031). Note that the arithmetic processing unit 812 rejects this cryptogram as an invalid cryptogram if the cryptogram C=(U₁, U₂, V, W) is not contained in a predetermined cryptogram space determined by the encryption system.

Next, the arithmetic unit 812 calculates Equation 119 by using the encryption/decryption unit 814 (S1032).

[Equation 119]
σᵢ=D_{SK}_{ᵢ}(Uᵢ) (i=1,2) (119)

Herein, D_{SK} (y) represents a result of decrypting a cryptogram y by using the secret key SK in the encryption system PKE.

Then, the arithmetic unit 812 calculates Equation 120 with respect to the cryptogram C stored in the storage unit 815 by employing the encryption/decryption unit 814 (S1033), and further calculates Mε{0,1}^{m} (m=n₁), R₁, R₂ε{0, 1}^{m} (m=n₂), τε{0, 1}^{m} (m=n₃), thereby checking Equation 121 (S1034).

[Equation 120]
M∥R₁∥R₂∥τ=V⊕H₁(σ₁,σ₂) 120
[Equation 121]
W=H₂(R₁,R₂,τ,M,σ₁,σ₂) (121)

Then, if the check is passed, the message text M is outputted via the output unit 817. If the check is not passed, the cryptogram C is considered as an invalid ciphertext and rejected.

The method according to the fifth embodiment of the present invention enables building up the new encryption system without depending on groups defined by existing encryption systems. Further, the fifth embodiment of the present invention has exemplified the case of building up another encryption system while utilizing an encryption method in an existing encryption system, and similarly enables configuring a new encryption system by providing the encryption system as a basis even when the existing encryption system does not exist.

The method according to the sixth embodiment of the present invention entails utilizing random self-reducibility defined as a mathematical property in the Bilinear Diffie-Hellman (BDH) problem and therefore uses dual encryption technology. Herein, the dual encryption denotes that the encryption and decryption in the existing encryption system are conducted twice. With this scheme, the public key crypto-communication method described in the first embodiment of the present invention proves secure in a random oracle model, when the existing encryption system is capable of proving security with tight security reduction in which the List Bilinear Diffie-Hellman (LBDH) problem is the cryptographic assumption, against a selected message text attack in the sense that existential forgery is impossible with the tight security reduction, while utilizing this system as a black box, in a way that treats the BDH problem as the cryptographic assumption, which is a more difficult problem in terms of quantity of calculations.

### Seventh Embodiment

Next, a seventh embodiment of the present invention will be described. This embodiment is a modified example of the fifth embodiment of the present invention. It is to be noted that this embodiment utilizes the conversion method described in Non-Patent Document 2.

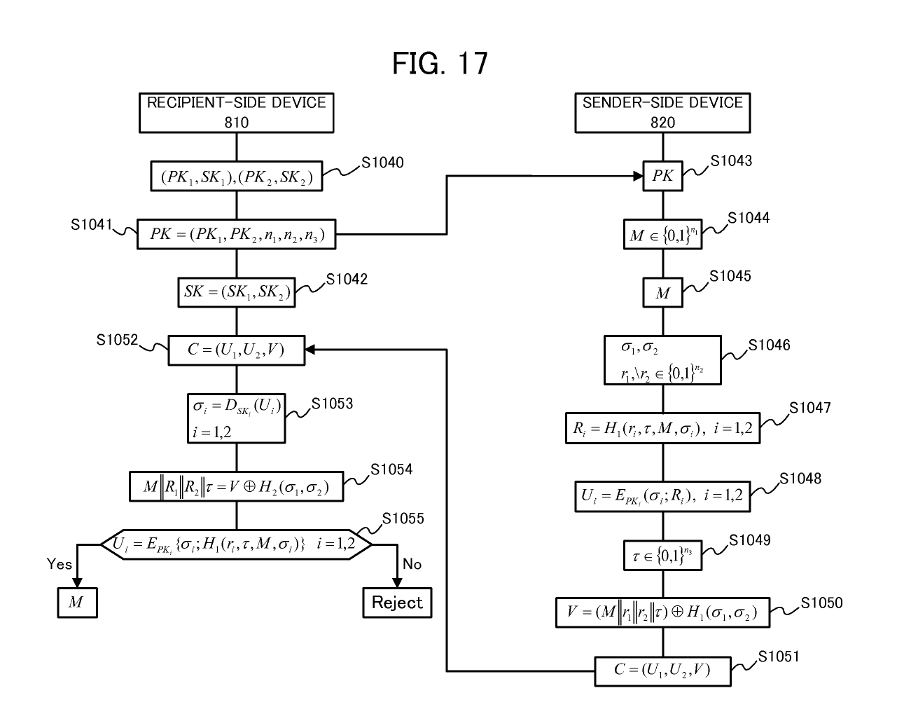

FIG. 17 is an explanatory diagram showing operation procedures in the seventh embodiment of the present invention.

1. Processes in Recipient-Side Device 810

In the recipient-side device 810, the arithmetic unit 812, when accepting a key generating instruction from the user via the input unit 811, executes twice a step for generating keys according to the encryption system PKE by employing the key information generating unit 813, thereby generating two pairs of keys (PK₁, SK₁,), (PK₂, SK₂) (S1040).

Next, the recipient-side device 810, upon accepting the instruction from the user via the input unit 811, discloses (PK in) Equation 122 (where n₁, n₂, n₃ are non-negative integers) as a new public key via the communication unit 816 or the output unit 817 (S1041), and stores (SK in) Equation 123 as a user's secret key of the recipient-side device 810 in the storage unit 815 (S1042).

[Equation 122]
PK=(PK₁,PK₂,n₁,n₂,n₃) (122)
[Equation 123]
SK=(SK₁,SK₂) (123)

2. Processes in Sender-Side Device 820

The arithmetic unit 822 of the sender-side device 820 acquires the public key PK open to the public by the recipient-side device 810 via the communication unit 826 or the input unit 821, and stores the public key PK in the storage unit 825 (S1043).

Next, the user of the sender-side device 820 inputs, via the input unit 821, a message text Mε{0,1}^{m}, m=n₁ (n₁ is a non-negative integer open to the public as a public key) (S1044).

When the message text M is input, the arithmetic unit 822 stores the input message text M in the storage unit 825 (S1045).

Next, the arithmetic unit 822, by use of the random number generating unit 823, selects at random σ₁, σ₂ contained in the message space of the encryption system PKE with respect to the message text M, and further selects at random R₁, R₂ε{0,1}^{m}, m=n₂ (n₂ is a non-negative integer open to the public as a public key) (S1046).

Then, the arithmetic unit 822 calculates Equation 124 by use of the encryption/decryption unit 824 (S1047).

[Equation 124]
Rᵢ=H₁(τᵢ,τ,M,σᵢ) (i=1,2) (124)

Further, the arithmetic unit 822 calculates Equation 125 by use of the encryption/decryption unit 824 (S1048).

[Equation 125]
Uᵢ=E_{PK}_{ᵢ}(σᵢ;Rᵢ) (i=1,2) (125)

Herein, E_{PK} (x;R) represents a result into which a message text x is encrypted according to the encryption system PKE by using the public key PK in a way that employs a random number R as with a coin toss in a probabilistic cryptosystem. That is, the cryptogram changes depending on the random number R.

Next, the arithmetic unit 822 selects τε{0,1}^{m}, m=n₃ (n₃ is a non-negative integer open to the public as a public key) at random by employing the random number generating unit 823 (S1049), and further calculates Equation 126 in a way that uses the encryption/decryption unit 824 (S1050).

[Equation 126]
V=(M∥r₁∥r₂∥τ)⊕H₂(σ₁,σ₂) (126)

Then, the arithmetic unit 822 of the sender-side device 820 outputs the cryptogram C=(U₁, U₂, V) generated in step S1050 from the output unit 827, or transmits the cryptogram C to the recipient-side device 810 via the communication line 140 from the communication unit 826 (S1051). Note that when the cryptogram C is output from the output unit 827, the user of the sender-side device 820 notifies the user, of the recipient-side device 810, of the cryptogram C by post, or the like.

3. Processes in Recipient-Side Device 810

The arithmetic unit 812 of the recipient-side device 810 stores the cryptogram C received by the communication unit 816 via the communication line 140 from the sender-side device 820 or input by the user of the recipient-side device 810 via the input unit 811 in the storage unit 815 (S1052). Note that the arithmetic processing unit 812, if the cryptogram C=(U₁, U₂, V) is not contained in a predetermined cryptogram space determined by the encryption system, rejects this ciphertext as an invalid one.

Next, the arithmetic unit 812 calculates Equation 127 by using the encryption/decryption unit 814 (S1053).

[Equation 127]
σᵢ=D_{SK}_{ᵢ}(Uᵢ) (i=1,2) (127)

Herein, D_{SK}(y) represents a result of decrypting a cryptogram y by using the secret key SK in the encryption system PKE.

Then, the arithmetic unit 812 calculates Equation 128 with respect to the cryptogram C stored in the storage unit 815 by employing the encryption/decryption unit 814 (S1054), and further calculates Mε{0,1}^{m} (m=n₁), r₁, r₂ε{0,1}^{m} (m=n₂), ξε{0,1}^{m} (m=n₃), thereby checking Equation 129 (S1055).

[Equation 128]
M∥r₁∥r₂∥τ=V⊕H₂(σ₁,σ₂) (128)
[Equation 129]
Uᵢ=E_{PK}_{ᵢ}(σᵢ;H₁(rᵢ,τ,M,σᵢ)) (i=1,2) (129)

Then, if the check is passed, the message text M is outputted via the output unit 817. If the check is not passed, the cryptogram C is considered as an invalid cryptogram and rejected.

The method according to this embodiment enables building up the new encryption system without depending on the group defined by the existing encryption systems. Further, this embodiment has exemplified the case of building up another encryption system while utilizing the encryption method in the existing encryption system, and similarly enables configuring a new encryption system by providing the encryption system as a basis even when the existing encryption system does not exist.

Further, as in the cases of the fifth embodiment and the sixth embodiment of the present invention, the method according to this embodiment is provably secure in a random oracle model, when the existing encryption system is secure in the sense of EUF-CMA (existentially unforgeable against chosen-message attacks) under the LBDH assumption (i.e., the LBDH problem is hard) with tight security reduction, while utilizing this system as a black box, in a way that treats the BDH problem as the cryptographic assumption, which is a more intractable problem.

Note: If there are the same descriptions in this document, please revise them with the same manner.

### Eighth Embodiment

An eighth embodiment of the present invention will exemplify a method by which the user B of the sender-side device 820 conducts, in a communication system 800 where the user A employing the recipient-side device 810 and the user B using the sender-side device 820 communicate with each other, the crypto-communications via the communication line 140 by employing the public key information generated in the recipient-side device 810 of the user A.

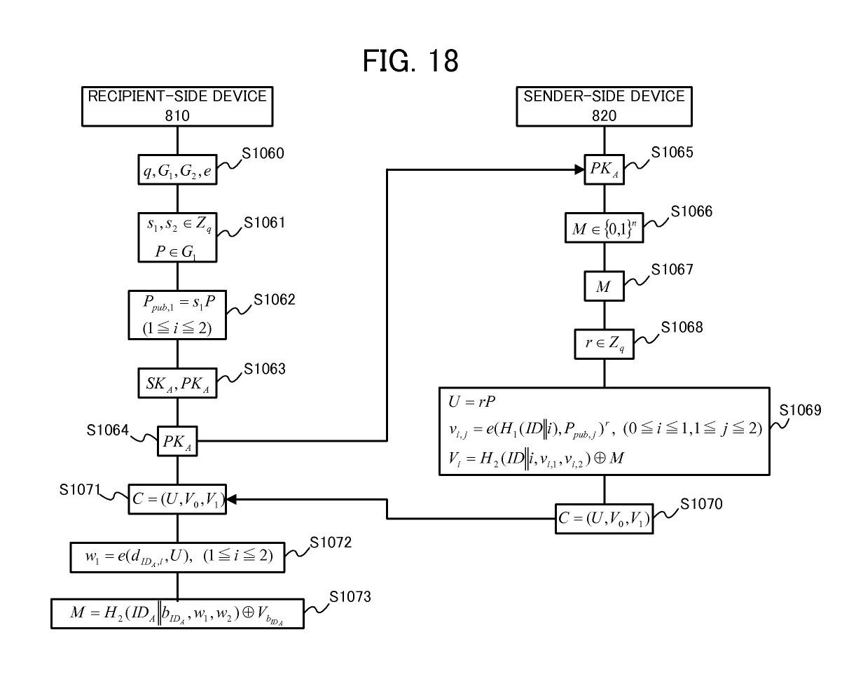

FIG. 18 is an explanatory diagram showing operation procedures in the eighth embodiment of the present invention.

1. Processes in Recipient-Side Device 810

In the recipient-side device 810, the arithmetic unit 812, when accepting a key generating instruction from the user A via the input unit 811, generates the prime number q, the additive group G₁ of the order q, the multiplicative group G₂ of the order q, and the bilinear mapping e given from Equation 130 by use of the key information generating unit 813 (S1060).

[Equation 130]
e:G₁×G₁→G₂ (130)

Next, the arithmetic unit 812 selects at random s₁, s₂εZ_{q} and PεG₁ by employing the key information generating unit 813 (S1061).

Then, the key information generating unit 813 of the arithmetic unit 812 generates Equation 131 by using s₁, S2 and P selected at random (S1062).

[Equation 131]
P_{pub,i}=sᵢP(1≦i≦2) (131)

Then, the arithmetic unit 812 sets SK_{A}=(d_{IDA,1}, d_{IDA,2}) as a decryption (secret) key and PK_{A}=(q, G₁, G₂, e, m, n, P, P_{pub,1}, P_{pub,2}, ID_{A}, H₁, H₂) as an encryption (public) key, and stores both the keys in the storage unit 815 (S1063). P_{pub,i} is obtained from Equation 132, m and n represent natural numbers, and ID_{A}ε{0,1}^{m}, H₁, H₂ denote hash functions given by Equation 133.

$$\begin{matrix}[ Equation 132 ] & \\ {d}_{{ID}_{A} , i} = {s}_{i} {H}_{1} ( {ID}_{A} ‖ {b}_{{ID}_{A}} ) ( 1 \leq i \leq 2 ) & ( 132 ) \\ [ Equation 133 ] & \\ \begin{matrix}{H}_{1} : {\{ 0 , 1 \}}^{m + 1} \to {G}_{1} , \\ {H}_{2} : {\{ 0 , 1 \}}^{m + 1} \times {G}_{2}^{2} \to {\{ 0 , 1 \}}^{n}\end{matrix} \} & ( 133 )\end{matrix}$$

Next, the arithmetic unit 812 outputs from the output unit 817 the encryption (public) key PK_{A}=(q, G₁, G₂, e, m, n, P, P_{pub,1}, P_{pub,2}, ID_{A}, H₁, H₂), or alternatively transmits the encryption (public) key PK_{A} to the sender-side device 820 from the communication unit 816 via the communication line 140 (S1064). It is to be noted that if the encryption (public) key PK_{A} is outputted from the output unit 817, the user A notifies the user B of the encryption (public) key PK_{A} by post, or the like.

2. Processes in Sender-Side Device 820

The arithmetic unit 822 of the sender-side device 820 stores the encryption (public) key PK_{A} received by the communication unit 826 from the recipient-side device 810 via the communication line 140 or inputted by the user B via the input unit 821 in the storage unit 825 (S1065).

Next, the user B inputs a message text Mε{0,1}ⁿ (n is a positive integer) via the input unit 821 (S1066).

Upon the input of the message text M, the arithmetic unit 822 stores the input message text M in the storage unit 825 (S1067).

Then, the arithmetic unit 822 selects at random rεZ_{q} with respect to the message M by use of the random number generating unit 823 (S1068), and calculates Equation 134. The arithmetic unit 822, using the encryption (public) key PK_{A} and the message M which are stored in the storage unit 125 and also using the encryption/decryption unit 124, calculates Equation 135 and further calculates Equation 136 (S1069).

[Equation 134]
U=rP (134)
[Equation 135]
υ_{i,j}=e(H₁(ID∥i),P_{pub,j})^{r}(0≦i≦1,1≦j≦2) (135)
[Equation 136]
Vᵢ=H₂(ID∥i,υ_{i,1},σ_{i,2})⊕M (136)

Then, the arithmetic unit 822 outputs a cryptogram C=(U, V₀, V₁) from the output unit 827, or alternatively transmits the cryptogram C to the recipient-side device 810 from the communication unit 826 via the communication line 140 (S1070). Note that if the cryptogram C is outputted from the output unit 827, the user B notifies the user A of the cryptogram C by post, or the like.

3. Processes in Recipient-Side Device 810

The arithmetic unit 812 of the recipient-side device 810 stores the cryptogram C received by the communication unit 816 from the sender-side device 820 via the communication line 140 or input by the user A via the input unit 811 in the storage unit 815 (S1071).

Next, the arithmetic unit 812, by use of the encryption/decryption unit 814, calculates Equation 137 from the decryption (secret) key SK_{A} of the user A stored in the storage unit 815 with respect to the cryptogram C stored in the storage unit 815 (S1072), and calculates Mε{0,1}ⁿ in Equation 138 (S1073).

[Equation 137]
wᵢ=e(d_{ID}_{_{A,}}ᵢ,U) (1≦i≦2) (137)

$$\begin{matrix}[ Equation 138 ] & \\ M = {H}_{2} ( {ID}_{A} \vert \vert {b}_{{ID}_{A} ,} {w}_{1} , {w}_{2} ) ⊕ {V}_{{b}_{{ID}_{A}}} & ( 138 )\end{matrix}$$

The public key crypto-communication method described in this embodiment is capable of proving, in the same way as disclosed in Non-Patent Document 1 and Non-Patent Document 4, the security in the sense of IND-CPA, in which the computational intractability of the BDH problem is a cryptographic assumption. Herein, supposing that there exists an algorithm capable of breaking the public key encryption system in this embodiment with an advantage ε in the sense of IND-CPA, it is shown that an algorithm capable of solving the BDH problem substantially with the advantage ε by use of the former algorithm can be built up. It is recognized from this point that the public key encryption system according to this embodiment has a tight security reduction.

The crypto-communication method according to the eighth embodiment of the present invention is capable of strengthening the security in the sense of IND-CCA by employing methods described in E. Fujisaki and T. Okamoto: How to enhance the security of the public-key encryption at minimum cost, PKC1999, LNCS1560. pp. 53-68, Springer-Verlag, 1999, (hereinafter, referred to as Non-Patent Document 6), and E. Fujisaki and T. Okamoto: Secure integration of asymmetric and symmetric encryption schemes, Crypto'99, LNCS 1666. pp. 537-554, Springer-Verlag, 1999, (hereinafter, referred to as Non-Patent Document 7).

Further, the encryption system according to this embodiment involves using the plurality of hash functions; however, it is possible to organize such a plurality of functions as to obtain different output values by previously setting plural values serving as seeds, separately from the input values, with respect to a single hash function. The hash function can be also given by this type of method.

Further, in the encryption method according to this embodiment, the method of generating V₀, V₁ (in Equation 136) is also capable of generating V₀, V₁ in a way that generates an encryption key K in the common key cryptography by use of H₂(ID∥ᵢ, V_{i,1}, V_{i,2}) and encrypts the message text M by employing the key K (using the common key cryptography).

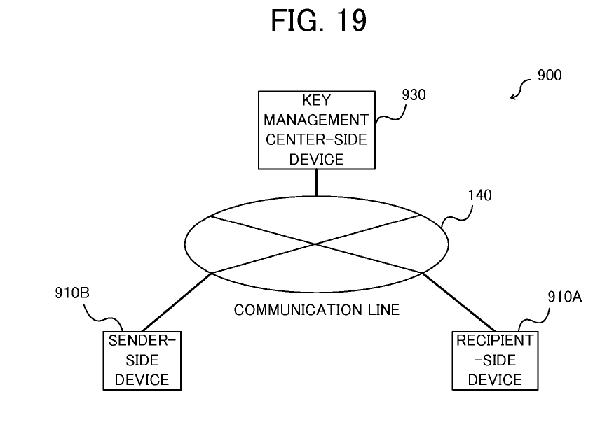

FIG. 19 is a schematic diagram of a communication system 900 common to a ninth embodiment, a tenth embodiment, an eleventh embodiment, and a twelfth embodiment of the present invention.

As illustrated in FIG. 19, the communication system 900 includes a recipient-side device 910A, a sender-side device 910B, and a key management center-side device 930, which are connected to the communication line 140.

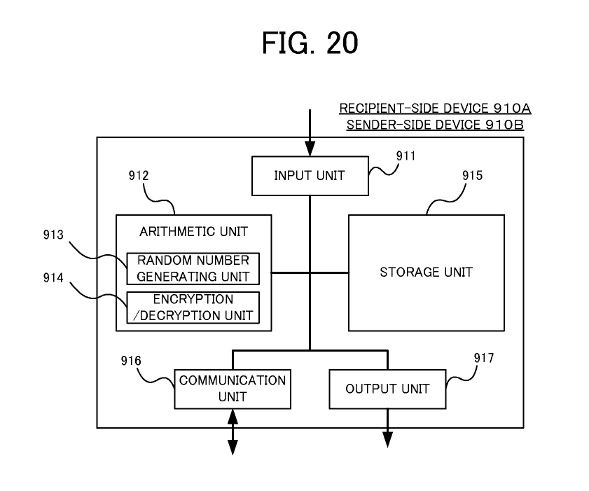

FIG. 20 is a schematic diagram of the recipient-side device 910A and the sender-side device 910B. The recipient-side device 910A and the sender-side device 910B in those embodiments mentioned above of the present invention have the same configuration.

As illustrated in FIG. 20, each of the recipient-side device 910A and the sender-side device 910B includes an input unit 911 which is used to input information, an arithmetic unit 912 which performs a variety of operations including a logical operation, exponentiation, remainder operation, hash function operation, and random function operation, and controls the respective units of the recipient-side device 910A or the sender-side device 910B, a storage unit 915, a communication unit 916 performing communications via the communication line 140, and an output unit 917 which outputs the information.

Further, the arithmetic unit 912 has a random number generating unit 913 which generates random numbers, and an encrypting/decrypting unit 914 which executes an encryption/decryption process.

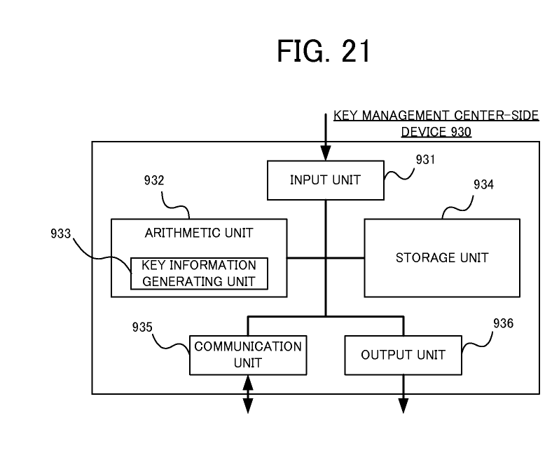

FIG. 21 is a schematic diagram of the key management center-side device 930.

As illustrated in FIG. 21, the key management center-side device 930 has an input unit 931 which is used to input information, an arithmetic unit 932 which performs a variety of operations including a logical operation, exponentiation, remainder operation, hash function operation, and random function operation, and controls the respective units of the key management center-side device 930, a storage unit 934, a communication unit 935 performing communications via the communication line 140 with the recipient-side device 910A and the sender-side device 910B, and an output unit 936 which outputs the information.

Further, the arithmetic unit 932 includes a key information generating unit 933 which generates a system parameter, a master key, and a private key.

The recipient-side device 910A, sender-side device 910B, and key management center-side device 930 having the above configuration can be realized such that the CPU 401 executes predetermined programs (program code) loaded into the memory 402 in a general type of computer 400, including, as illustrated in FIG. 4, the CPU 401, the memory 402, the external storage device 403 such as a HDD, the reading device 404 which reads the information from the storage medium 409 having portability such as a CD-ROM or a DVD-ROM, the input device 405 such as a keyboard or a mouse, the output device 406 such as a display, the communication device 407 which communicates with the partner communication device via the communication line 300, and the bus 408 which connects the respective devices to each other. In this case, the memory 402 and the external storage device 403 are utilized for the storage units 915 and 934, the communication device 407 is utilized for the communication units 916 and 935, the input device 405 and the reading device 404 are employed for the input units 911 and 931, and the output device 406 is used for the output units 917 and 936.

The predetermined programs (program code) may also be downloaded into the external storage device 403 from the storage medium 409 via the reading device 404 or from the communication line 140 via the communication device 407, and loaded into the memory 402, whereby the CPU 401 may execute the programs. Further, the programs may also be loaded directly into the memory 402 from the storage medium 409 via the reading device 404 or from the communication line 140 via the communication device 407, whereby the CPU 401 may execute the programs.

Note that the programs can be provided as a program product while being stored on the storage medium.

### Ninth Embodiment

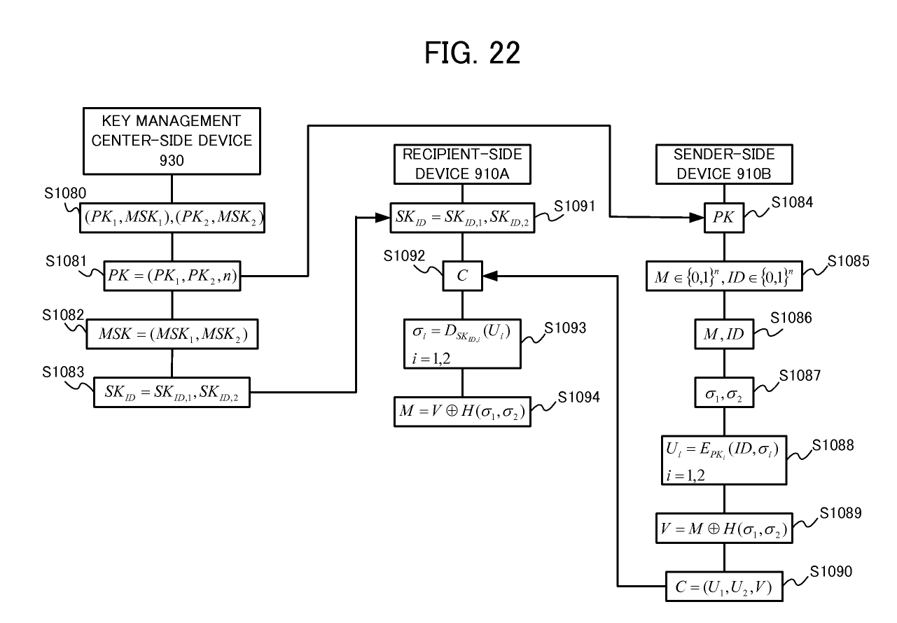

FIG. 22 is an explanatory diagram showing operation procedures in a ninth embodiment of the present invention. In this embodiment, the method described in the fifth embodiment of the present invention is applied to the ID-based cryptography. Then, this embodiment will describe a case of building up, in the same way as in the fifth embodiment of the present invention, on the assumption of a state where the crypto-communication system utilizing the ID-based encryption (which will hereinafter be referred to as encryption system IBE) already exists, another encryption system (exhibiting the higher security) while utilizing the encryption system IBE in an existing encryption system.

It is to be noted that the recipient-side device 910A, the sender-side device 910B, and the key management center-side device 930 in the ninth embodiment of the present invention support a certain encryption system IBE.

1. Processes in Key Management Center-Side Device 930

The arithmetic unit 932 of the key management center-side device 930, when accepting the key generating instruction from the user via the input unit 931, executes twice a step of setting up the encryption system IBE by employing the key information generating unit 933, thereby generating two pairs of keys (PK₁, MSK₁), (PK₂, MSK₂) (S1080).

Next, the recipient-side device 810, when receiving the instruction from the user via the input unit 811, opens (PK given by) Equation 139 (where n is the non-negative integer) to the public as a system parameter via the communication unit 935 or the output unit 936 (S1081), and stores (MSK given by) Equation 140 as a master key of the key management center in the storage unit 934 (S1082).

[Equation 139]
PK=(PK₁,PK₂,n) (139)
[Equation 140]
MSK=(MSK₁,MSK₂) (140)

Then, the arithmetic unit 932 of the key management center-side device 930, upon accepting a private key generating instruction from the user via the input unit 931, generates two pairs of private keys SK_{ID, 1}, SK_{ID, 2} by repeating twice a step of generating the private key in the encryption system IBE by use of the key information generating unit 933 with respect to the user specified by ID information which is IDε{0, 1}^{m}, m=n (n is the non-negative integer open to the public as the system parameter), and transmits or outputs those pairs of private keys SK_{ID} to the recipient-side device 910A via the communication unit 935 or the output unit 936 (S1083).

2. Processes in Sender-Side Device 910B

The arithmetic unit 912 of the sender-side device 910B acquires the system parameter PK open to the public by the key management center-side device 930 via the communication unit 916 or the input unit 911, and stores the system parameter PK in the storage unit 915 (S1084).

Next, the user of the sender-side device 910B inputs via the input unit 911 the message text Mε{0,1}^{m}, m=n (n is the non-negative integer open to the public as the system parameter) and IDε{0, 1}^{m}, m=n (n is the non-negative integer open to the public as the system parameter) defined as the ID information of the user of the recipient-side device 910A (S1085).

When the message text M and the ID information are input, the arithmetic unit 912 stores the input message M and the ID information in the storage unit 915 (S1086).

Next, the arithmetic unit 912, by use of the random number generating unit 913, selects at random σ₁, σ₂ contained in the message space of the encryption system IBE with respect to the message text M and the ID information (S1087).

Then, the arithmetic unit 912 calculates Equation 141 by use of the encryption/decryption unit 914 (S1088).

[Equation 141]
Uᵢ=E_{PK}_{ᵢ}(ID,σᵢ) (i=1,2) (141)

Herein, E_{PK} (x) represents a result into which a message text x is encrypted according to the encryption system IBE by using the system parameter PK.

Further, the arithmetic unit 912 calculates Equation 142 by use of the encryption/decryption unit 914 (S1089).

[Equation 142]
V=M⊕H(σ₁,σ₂) (142)

Then, the arithmetic unit 912 of the sender-side device 910B outputs the cryptogram C=(U₁, U₂, V) generated in step S1089 from the output unit 917, or transmits the cryptogram C to the recipient-side device 910A via the communication line 140 from the communication unit 916 (S1090). Note that when the cryptogram C is output from the output unit 917, the user of the sender-side device 910B notifies the user, of the recipient-side device 910A, of the cryptogram C by post, or the like.

3. Processes in Recipient-Side Device 910A

The arithmetic unit 912 of the recipient-side device 910A acquires the private key SK_{ID} from the key management center-side device 930, and stores the private key SK_{ID} in the storage unit 915 (S1091).

Further, the arithmetic unit 912 of the recipient-side device 910A stores the cryptogram C received by the communication unit 916 via the communication line 140 from the sender-side device 910B or input by the user of the recipient-side device 910A via the input unit 911 in the storage unit 915 (S1092). Note that the arithmetic processing unit 912, if the cryptogram C=(U₁, U₂, V) is not contained in a predetermined cryptogram space determined by the encryption system, rejects this cryptogram as an invalid cryptogram.

Next, the arithmetic unit 912 calculates Equation 143 by using the encryption/decryption unit 914 (S1093).

[Equation 143]
σᵢ=D_{SK}_{_{ID,i}}(Uᵢ) (i=1,2) (143)

Herein, D_{SKID} (y) represents a result of decrypting a cryptogram y by using the secret key SK_{ID} in the encryption system IBE.

Then, the arithmetic unit 912 decrypts the message M by calculating Equation 144 with respect to the cryptogram C stored in the storage unit 915 by using the encryption/decryption unit 914 (S1094).

[Equation 144]
M=V⊕H(σ₁,σ₂) (144)

The method according to this embodiment enables building up the new encryption system without depending on a group defined by existing encryption systems. Further, this embodiment has exemplified the case of building up another encryption system while utilizing an encryption method of an existing encryption system, and similarly enables configuring a new encryption system by providing the encryption system as a basis, even when the existing encryption system does not exist.

### Tenth Embodiment

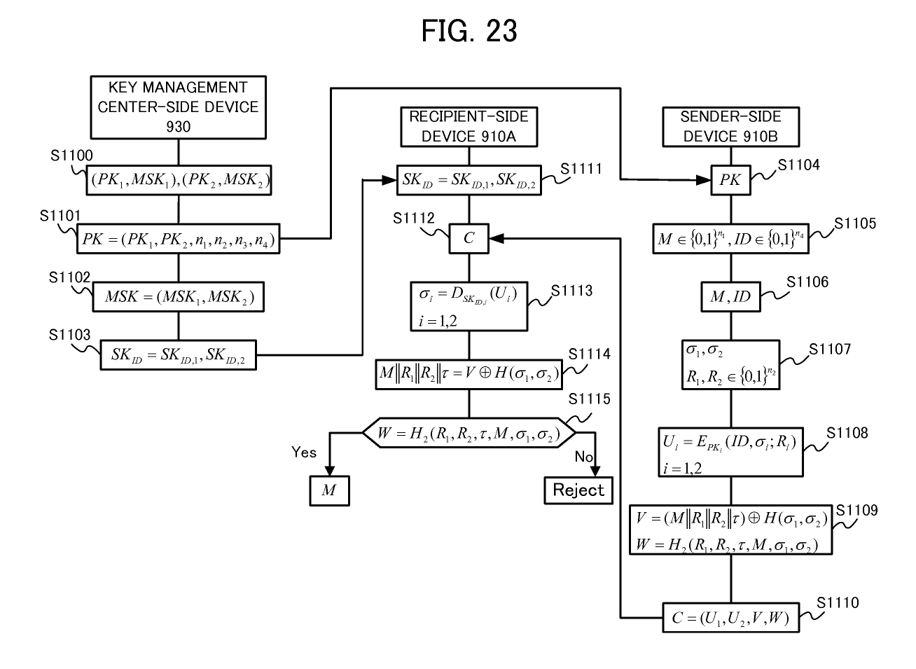

FIG. 23 is an explanatory diagram showing operation procedures in a tenth embodiment of the present invention. In this embodiment, the method according to the sixth embodiment of the present invention is applied to the ID-based cryptography.

1. Processes in Key Management Center-Side Device 930

The arithmetic unit 932 of the key management center-side device 930, when accepting the key generating instruction from the user via the input unit 931, executes twice a step of setting up the encryption system IBE by employing the key information generating unit 933, thereby generating two pairs of keys (PK₁, MSK₁), (PK₂, MSK₂) (S1100).

Next, the recipient-side device 810, when receiving the instruction from the user via the input unit 811, opens (PK given by) Equation 145 (where n₁, n₂, n₃ and n₄ are the non-negative integers) to the public as a system parameter via the communication unit 935 or the output unit 936 (S1101), and stores (MSK given by) Equation 146 as a master key of the key management center in the storage unit 934 (S1102).

[Equation 145]
PK=(PK₁,PK₂,n₁,n₂,n₃,n₄) (145)
[Equation 146]
MSK=(MSK₁,MSK₂) (146)

Then, the arithmetic unit 932 of the key management center-side device 930, upon accepting a private key generating instruction from the user via the input unit 931, generates two pairs of private keys SK_{ID, 1}, SK_{ID, 2} by repeating twice a step of generating the private key in the encryption system IBE by use of the key information generating unit 933 with respect to the user specified by ID information which is IDε{0, 1}^{m}, m=n₄ (n₄ is the non-negative integer open to the public as the system parameter), and transmits or outputs those pairs of private keys SK_{ID} to the recipient-side device 910A via the communication unit 935 or the output unit 936 (S1103).

2. Processes in Sender-Side Device 910B

The arithmetic unit 912 of the sender-side device 910B acquires the system parameter PK open to the public by the key management center-side device 930 via the communication unit 916 or the input unit 911, and stores the system parameter PK in the storage unit 915 (S1104).

Next, the user of the sender-side device 910B inputs via the input unit 911 the message text Mε{0,1}^{m}, m=n₁ (n₁ is the non-negative integer open to the public as the system parameter) and IDε{0, 1}^{m}, m=n₄ (n₄ is the non-negative integer open to the public as the system parameter) defined as the ID information of the user of the recipient-side device 910A (S1105).

When the message text M and the ID information are input, the arithmetic unit 912 stores the input message text M and the ID information in the storage unit 915 (S1106).

Next, the arithmetic unit 912, by use of the random number generating unit 913, selects at random σ₁, σ₂ contained in the message space of the encryption system IBE with respect to the message text M and the ID information, and further selects at random R₁, R₂ε{0,1}^{m}, m=n₂ m=n₂ (n₂ is a non-negative integer open to the public as the system parameter) (S1107).

Then, the arithmetic unit 912 calculates Equation 147 by use of the encryption/decryption unit 914 (S1108).

[Equation 147]
Uᵢ=E_{PK}_{ᵢ}(ID,σᵢ;Rᵢ) (i=1,2) (147)

Herein, E_{PK} (ID, x;R) represents a result into which a message text x is encrypted according to the encryption system IBE by using the system parameter PK in a way that employs a random number R as with a coin toss in a probabilistic cryptosystem.

Further, the arithmetic unit 912 calculates Equation 148 by use of the encryption/decryption unit 914 (S1109).

$$\begin{matrix}[ Equation 148 ] & \\ \begin{matrix}V = ( M ‖ {R}_{1} ‖ {R}_{2} ‖ τ ) ⊕ {H}_{1} ( {σ}_{1} , {σ}_{2} ) \\ W = {H}_{2} ( {R}_{1} , {R}_{2} , τ , M , {σ}_{1} , {σ}_{2} )\end{matrix} \} & ( 148 )\end{matrix}$$

Then, the arithmetic unit 912 of the sender-side device 910B outputs the cryptogram C=(U₁, U₂, V, W) generated in step S1089 from the output unit 917, or transmits the cryptogram C to the recipient-side device 910A via the communication line 140 from the communication unit 916 (S1100). Note that when the cryptogram C is outputted from the output unit 917, the user of the sender-side device 910B notifies the user, of the recipient-side device 910A, of the cryptogram C by post, or the like.

3. Processes in Recipient-Side Device 910A

The arithmetic unit 912 of the recipient-side device 910A acquires the private key SK_{ID} from the key management center-side device 930, and stores the private key SK_{ID} in the storage unit 915 (S1111).

The arithmetic unit 912 of the recipient-side device 910A stores the cryptogram C received by the communication unit 916 via the communication line 140 from the sender-side device 910B or input by the user of the recipient-side device 910A via the input unit 911 in the storage unit 915 (S1112). Note that the arithmetic processing unit 912, if the cryptogram C=(U₁, U₂, V, W) is not contained in a predetermined cryptogram space determined by the encryption system, rejects this cryptogram as an invalid cryptogram.

Next, the arithmetic unit 912 calculates Equation 149 by using the encryption/decryption unit 914 (S1113). Herein, D_{SKID} (Y) represents a result of decrypting a cryptogram y by using the secret key SK_{ID} in the encryption system IBE.

[Equation 149]
σᵢ=D_{SK}_{_{ID,i}}(Uᵢ) (i=1,2) (149)

Then, the arithmetic unit 912 calculates Equation 150 with respect to the cryptogram C stored in the storage unit 915 by employing the encryption/decryption unit 914 (S1114), and further calculates Mε{0,1}^{m} (m=n₁), R₁, R₂ε{0, 1}^{m} (m=n₂), τε{0, 1}^{m} (m=n₃), thereby checking Equation 151 (S1115).

[Equation 150]
M∥R₁∥R₂∥τ=V⊕H₁(σ₁,σ₂) (150)
[Equation 151]
W=H₂(R₁,R₂,τ,M,σ₁,σ₂) (151)

Then, if passing the check, the message text M is output via the output unit 817. If the check is not passed, the cryptogram C is rejected as an invalid cryptogram.

The method according to the ninth embodiment enables the new encryption system to be built up without depending on a to-be-defined group of the existing encryption systems. Further, the fifth embodiment has exemplified the case of building up another encryption system while utilizing the encryption method in the existing encryption system, and enables a new encryption system to be similarly configured by providing the encryption system as a basis even when the existing encryption system does not exist.

Further, the public key crypto-communication method described in the first embodiment proves to be secure in a random oracle model, when the existing encryption system is capable of proving security with tight security reduction in which the LBDH problem is the cryptographic assumption, against a selected message text attack in the sense that existential forgery is impossible with the tight security reduction, while utilizing this system as a black box, in a way that treats the BDH problem as the cryptographic assumption, which is a more difficult problem in terms of the quantity of calculations.

### Eleventh Embodiment

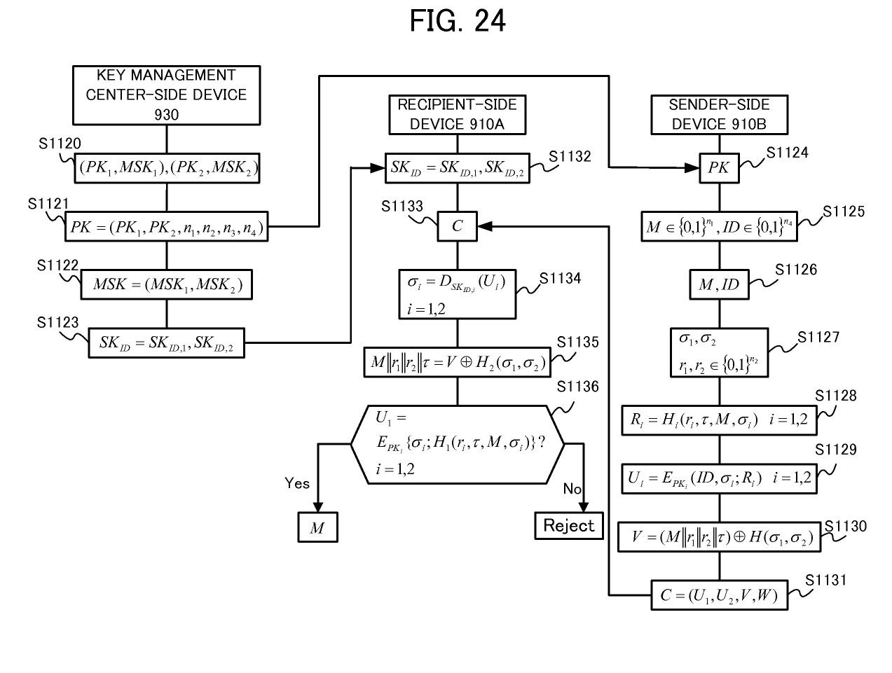

FIG. 24 is an explanatory diagram showing operation procedures in an eleventh embodiment of the present invention. In the eleventh embodiment, the method according to the seventh embodiment is applied to the ID-based cryptography.

1. Processes in Key Management Center-Side Device 930

An arithmetic unit 932 of the key management center-side device 930, when accepting the key generating instruction from the user via the input unit 931, executes twice a step for setting up the encryption system IBE by employing the key information generating unit 933, thereby generating two pairs of keys (PK₁, MSK₁), (PK₂, MSK₂) (S1120).

Next, the recipient-side device 810, when receiving the instruction from the user via the input unit 811, opens (PK given by) Equation 152 (where n₁, n₂, n₃ and n₄, are the non-negative integers) to the public as a system parameter via the communication unit 935 or the output unit 936 (S1121), and stores (MSK given by) Equation 153 as a master key of the key management center in the storage unit 934 (S1122).

[Equation 152]
PK=(PK₁,PK₂,n₁,n₂,n₃,n₄) (152)
[Equation 153]
MSK=(MSK₁,MSK₂) (153)

Then, the arithmetic unit 932 of the key management center-side device 930, upon accepting a private key generating instruction from the user via the input unit 931, generates two pairs of private keys SK_{ID, 1}, SK_{ID, 2} by repeating twice a step for generating the private key in the encryption system IBE by use of the key information generating unit 933 with respect to the user specified by ID information which is IDε{0, 1}^{m}, m=n₄ (n₄ is the non-negative integer open to the public as the system parameter), and transmits or outputs these pairs of private keys SK_{ID} via the communication unit 935 or the output unit 936 to the recipient-side device 910A (S1123).

2. Processes in Sender-Side Device 910B

The arithmetic unit 912 of the sender-side device 910B acquires the system parameter PK open to the public by the key management center-side device 930 via the communication unit 916 or the input unit 911, and stores the system parameter PK in the storage unit 915 (S1124).

Next, the user of the sender-side device 910B inputs via the input unit 911 the message text Mε{0,1}^{m}, m=n₁ (n₁ is the non-negative integer open to the public as the system parameter) and IDε{0, 1}^{m}, m=n₄ (n₄ is the non-negative integer open to the public as the system parameter) defined as the ID information of the user of the recipient-side device 910A (S1125).

When inputting the message text M and ID information, the arithmetic unit 912 stores the input message M and the ID information in the storage unit 915 (S1126).

Next, the arithmetic unit 912, by use of the random number generating unit 913, selects at random σ₁, σ₂ contained in the message space of the encryption system IBE with respect to the message text M and the ID information, and further selects at random r₁, r₂ε{0,1}^{m}, m=n₂ (n₂ is a non-negative integer open to the public as the system parameter) (S1127).

Then, the arithmetic unit 912 calculates Equation 154 by use of the encryption/decryption unit 914 (S1128).

[Equation 154]
Rᵢ=H₁(rᵢ,τ,M,σᵢ) (i=1,2) (154)

Then, the arithmetic unit 912 calculates Equation 155 by use of the encryption/decryption unit 914 (S1129).

[Equation 155]
Uᵢ=E_{PK}_{ᵢ}(ID,σᵢ;Rᵢ) (i=1,2) (155)

Herein, E_{PK} (ID, x;R) represents a result into which a message text x is encrypted based on the encryption system PKE by using the system parameter PK in a way that employs a random number R as with a coin toss in a probabilistic cryptosystem.

Further, the arithmetic unit 912 selects τε{0,1}^{m}, m=n₃ (n₃ is a non-negative integer open to the public as a public key) at random by employing the random number generating unit 913 (S1028), and further calculates Equation 156 in a way that uses the encryption/decryption unit 914 (S1130).

[Equation 156]
V=(M∥r₁∥r₂∥τ)⊕H₂(σ₁,σ₂) (156)

Then, the arithmetic unit 912 of the sender-side device 910B outputs the cryptogram C=(U₁, U₂, V, W) generated in step S1130 from the output unit 917, or transmits the cryptogram C to the recipient-side device 910A via the communication line 140 from the communication unit 916 (S1131). Note that when the cryptogram C is outputted from the output unit 917, the user of the sender-side device 910B notifies the user of the recipient-side device 910A of the cryptogram C by post, or the like.

3. Processes in Recipient-Side Device 910A

The arithmetic unit 912 of the recipient-side device 910A acquires the private key SK_{ID} from the key management center-side device 930, and stores the private key SK_{ID} in the storage unit 915 (S1132).

The arithmetic unit 912 of the recipient-side device 910A stores the cryptogram C received by the communication unit 916 via the communication line 140 from the sender-side device 920B or inputted by the user of the recipient-side device 910A via the input unit 911 in the storage unit 915 (S1133). Note that the arithmetic processing unit 912, if the cryptogram C=(U₁, U₂, V, W) is not contained in a predetermined cryptogram space determined by the encryption system, rejects this cryptogram as an invalid cryptogram.

Next, the arithmetic unit 912 calculates Equation 157 by using the encryption/decryption unit 914 (S1134).

[Equation 157]
σᵢ=D_{SK}_{_{ID,i}}(Uᵢ) (i=1,2) (157)

Herein, D_{SKID} (y) represents a result of decrypting a cryptogram y by using the secret key SK_{ID} in the encryption system IBE.

Then, the arithmetic unit 912 calculates Equation 158 with respect to the cryptogram C stored in the storage unit 915 by employing the encryption/decryption unit 914 (S1135), and further calculates Mε{0,1}^{m} (m=n₁), R₁, R₂ε{0, 1}^{m} (m=n₂), τε{0,1}^{m} (m=n₃), thereby checking Equation 159 (S1136).

[Equation 158]
M∥r₁∥r₂∥τ=V⊕H₂(σ₁,σ₂) (158)
[Equation 159]
Uᵢ=E_{PK}_{ᵢ}(σᵢ;H₁(rᵢ,τ,M,σᵢ)) (i=1,2) (159)

Then, if passing the check, the message text M is output via the output unit 817. If the check is not passed, the cryptogram C is rejected as an invalid cryptogram.

The method according to the fifth embodiment enables the new encryption system to be built up without depending on the to-be-defined group of the existing encryption systems. Further, the fifth embodiment has exemplified the case of building up another encryption system while utilizing the encryption method in the existing encryption system, and enables a new encryption system to be similarly configured by providing the encryption system as a basis even when the existing encryption system does not exist.

Further, the public key crypto-communication method described in the six or seventh embodiment proves to, when the existing encryption system is incapable of proving the security with the tight security reduction in which the LBDH problem is the cryptographic assumption, be secure in a random oracle model against a selected message text attack in a sense that existential forgery is impossible with the tight security reduction, while utilizing this system as a black box, in a way that treats the BDH problem as the cryptographic assumption, which is a more difficult problem in terms of the quantity of calculations.

### Twelfth Embodiment

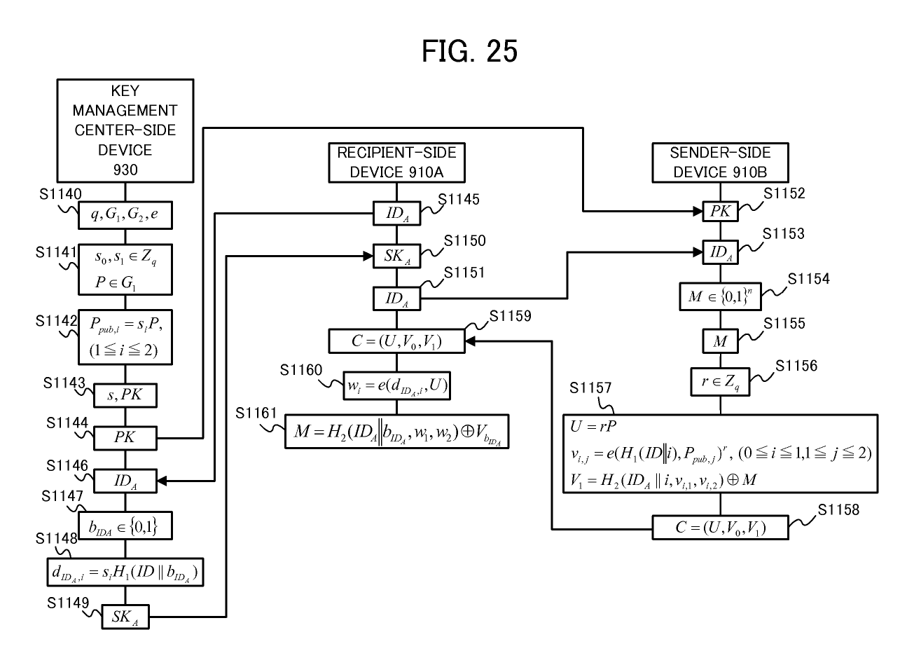

FIG. 25 is an explanatory diagram showing operation procedures in a twelfth embodiment of the present invention.

The twelfth embodiment will discuss a method by which the user A employing the recipient-side device 910A and the user B using the sender-side device 910B, perform the crypto-communications via the communication line 140 by use of the key information generated by the key management center-side device 930.

1. Processes in Key Management Center-Side Device 930

In the key management center-side device 930, the arithmetic unit 932, when accepting a key generating instruction from a manager at a key management center via the input unit 931, generates the prime number q, the additive group G₁ of the order q, the multiplicative group G₂ of the order q and the bilinear mapping e given from Equation 160 by use of the key information generating unit 933 (S1140).

[Equation 160]
e:G₁×G₁→G₂ (160)

Next, the arithmetic unit 932 selects at random s₁, s₂εZ_{q} and PεG₁ by use of the key information generating unit 233 (S1141).

Then, the key information generating unit 933 of the arithmetic unit 932 generates Equation 161 by employing s₁, s₂, and P selected at random (S1142).

[Equation 161]
P_{pub,i}=sᵢP(1≦i≦2) (161)

Subsequently, the arithmetic unit 932 stores both of s=(s₁, s₂) as a master key and PK=(q, G₁, G₂, e, l, m, n, P, P_{pub,1}, P_{pub,2}, H₁, H₂, E, D) as system parameters in the storage unit 934 (S1143). Herein, l, m, n represent natural numbers, E represents an encryption function in common key cryptography, D designates a decryption function in the common key cryptography, and H₁, H₂ denote hash functions given by Equation 162.

$$\begin{matrix}[ Equation 162 ] & \\ \begin{matrix}{H}_{1} : {\{ 0 , 1 \}}^{m + 1} \to {G}_{1} , \\ {H}_{2} : {\{ 0 , 1 \}}^{m + 1} \times {G}_{2}^{2} \to {\{ 0 , 1 \}}^{n}\end{matrix} \} & ( 162 )\end{matrix}$$

Next, the arithmetic unit 932 outputs the system parameter PK from the output unit 936, or alternatively transmits the system parameter PK to the sender-side device 910B via the communication line 140 from the communication unit 935 (S1144). Note that if the system parameter PK is outputted from the output unit 936, the key management center notifies the user B of the system parameter PK by post, or the like.

2. Processes in Recipient-Side Device 910A

In the recipient-side device 910A, the arithmetic unit 912 stores individual information ID_{A} of the user A, which is accepted from the user A via the input unit 911, in the storage unit 915, and transmits the ID_{A} to the key management center-side device 930 from the communication unit 916 via the communication line 140 (S1145). Note that the user A may notify the key management center of the individual information ID_{A} of the user A together with an address of the recipient-side device 910A by post, or the like.

3. Processes in Key Management Center-Side Device 930

In the key management center-side device 930, the arithmetic unit 932 stores the individual information ID_{A} of the user A, which has been received by the communication unit 935 via the communication line 140 from the recipient-side device 910A or input together with the address of the recipient-side device 910A via the input unit 931, in the storage unit 934, in a way that associates the individual information ID_{A} with the address of the recipient-side device 910A (S1146).

Then, the arithmetic unit 932 selects at random b_{IDA}ε{0,1} by using the key information generating unit 933 (S1147).

Next, the arithmetic unit 932 calculates Equation 163 from the master key s and the individual information ID_{A} of the user A which are stored in the storage unit 934 by use of the key information generating unit 933 (S1148).

[Equation 163]
d_{ID}_{_{A,}}ᵢ=sᵢH₁(ID_{A}∥b_{ID}_{_{A}}) (1≦i≦2) (163)

Then, the arithmetic unit 932 outputs SK_{A}=(b_{IDA}, d_{IDA,1}, d_{IDA,2}) as a private key of the user A from the output unit 936, or transmits the SK_{A}=(b_{IDA}, d_{IDA,1}, d_{IDA,2}) to the recipient-side device 910A from the communication unit 935 via the communication line 140 by a secure method (e.g., through the crypto-communications using the encryption key shared between the key management center-side device 930 and the recipient-side device 910A) (S1149). Note that if the private key SK_{A} is outputted from the output unit 936, the key management center notifies the user A of the private key SK_{A} by a secure method such as posting an IC card.

4. Processes in Recipient-Side Device 910A

In the recipient-side device 910A, the arithmetic unit 912 stores the private key SK_{A} received by the communication unit 916 via the communication line 140 from the key management center-side device 930 or input via the input unit 911 in the storage unit 915 (S1150).

Further, the arithmetic unit 912, when receiving an instruction of transmitting the individual information ID_{A} of the user A via the input unit 911 from the user A, transmits the individual information ID_{A} of the user A from the communication unit 916 via the communication line 140 (S1151).

5. Processes in Sender-Side Device 910B

In the sender-side device 910B, the arithmetic unit 912 stores the system parameter PK received by the communication unit 916 from the key management center-side device 930 via the communication line 140 or input via the input unit 911 in the storage unit 915 (S1152).

Further, in the sender-side device 910B, the arithmetic unit 912 stores the individual information ID_{A} of the user A received by the communication unit 916 from the recipient-side device 910A via the communication line 140 or input via the input unit 911 in the storage unit 915 (S1153).

Next, the user B inputs the message text Mε{0,1}ⁿ (n is the positive integer) via the input unit 911 (S1154).

Upon input of the message text M, the arithmetic unit 912 stores the input message text M in the storage unit 915 (S1155).

Then, the arithmetic unit 912 selects at random rεZ_{q} by use of the random number generating unit 913 (S1156), and calculates Equation 164.

[Equation 164]
U=rP (164)

The arithmetic unit 912, using the message text M, the system parameter PK, the individual information ID_{A} of the user A, and the individual information ID_{B} of the user B which are stored in the storage unit 915, calculates Equation 165 and further calculates Equation 166 (S1157).

[Equation 165]
υ_{i,j}=e(H₁(ID∥i),P_{pub,j})^{r}(0≦i≦1,1≦j≦2) (165)
[Equation 166]
Vᵢ=H₂(ID∥i,υ_{i,1},υ_{i,2})⊕M (166)

Then, the arithmetic unit 912 outputs a cryptogram C=(U, V₀, V₁) from the output unit 917, or alternatively transmits the cryptogram C to the recipient-side device 910A from the communication unit 916 via the communication line 140 (S1158). Note that if the cryptogram C is outputted from the output unit 917, the user B notifies the user A of the cryptogram C by post, or the like.

3. Processes in Recipient-Side Device 910A

The arithmetic unit 912 of the recipient-side device 910A stores the cryptogram C received by the communication unit 916 from the sender-side device 910B via the communication line 140 or inputs by the user A via the input unit 911 in the storage unit 915 (S1159).

Next, the arithmetic unit 912, by use of the encryption/decryption unit 914, calculates Equation 167 from the individual information ID_{A} and private key SK_{A} of the user A that are stored in the storage unit 915 with respect to the cryptogram C stored in the storage unit 915 (S1160), and further calculates Mε{0,1}ⁿ in Equation 168 (S1161).

[Equation 167]
wᵢ=e(d_{ID}_{_{A,}}ᵢ,U) (1≦i≦2) (167)

$$\begin{matrix}[ Equation 168 ] & \\ M = {H}_{2} ( {ID}_{A} \vert \vert {b}_{{ID}_{A} ,} {w}_{1} , {w}_{2} ) ⊕ {V}_{{b}_{{ID}_{A}}} & ( 168 )\end{matrix}$$

The public key crypto-communication method described in this embodiment is capable of proving, in the same way as disclosed in Non-Patent Document 1 and Non-Patent Document 4, the security in the sense of IND-ID-CPA, in which the computational intractability of the BDH problem is a cryptographic assumption. Herein, supposing that there exists an algorithm capable of breaking the public key encryption system in this embodiment with an advantage ε in the sense of IND-ID-CPA, it is shown that an algorithm capable of solving the BDH problem substantially with the advantage ε by use of the former algorithm can be built up. It is recognized from this point that the public key encryption system according to this embodiment has tight security reduction.

The crypto-communication method according to this embodiment is capable of strengthening security in the sense of IND-ID-CPA by employing methods described in Non-Patent Documents 6 and 7 mentioned above.

Further, the encryption system in this embodiment involves using the plurality of hash functions; however, it is possible to organize such a plurality of functions so as to obtain different output values by previously setting plural values serving as seeds, separately from the input values, with respect to a single hash function. The hash function can be also given by this type of method.

Further, in the encryption method according to this embodiment, the method of generating V₀, V₁ (in Equation 136) is also capable of generating V₀, V₁ in a way that generates an encryption key K in the common key cryptography by use of H₂(ID∥ᵢ, v_{i,1}, v_{i,2}) and encrypts the message text M by employing the key K (using the common key cryptography).

The twelfth embodiment described above has exemplified a general mode in which the users perform the crypto-communications by using the individual devices, but can be specifically applied to a variety of systems. For example, in an electronic shopping system, the user as sender is a consumer, the user as recipient is a retail shop, and the user-side device is a computer such as a PC. Moreover, in an electronic mail system, the respective devices are computers such as PCs. In addition, the scheme can be applied to a variety of systems which employ conventional public keys cryptography and ID-based cryptography. Further, the respective calculations in this embodiment discussed above have been described as those made by the CPU executing programs in memory; however, without being limited to the programs, any one of the calculations may be performed by an arithmetic device implemented as hardware, and this arithmetic device may transmit and receive the data to and from other arithmetic devices and the CPU.

FIG. 1

110 RECIPIENT-SIDE DEVICE
120 SENDER-SIDE DEVICE
140 COMMUNICATION LINE
   FIG. 2
110 RECIPIENT-SIDE DEVICE
111 INPUT UNIT
112 ARITHMETIC UNIT
113 KEY INFORMATION GENERATING UNIT
114 ENCRYPTION/DECRYPTION UNIT
115 STORAGE UNIT
116 COMMUNICATION UNIT
117 OUTPUT UNIT
   FIG. 3
120 SENDER-SIDE DEVICE
121 INPUT UNIT
122 ARITHMETIC UNIT
123 RANDOM NUMBER GENERATING UNIT
124 ENCRYPTION/DECRYPTION UNIT
125 STORAGE UNIT
126 COMMUNICATION UNIT
127 OUTPUT UNIT
   FIG. 4
402 MEMORY
403 EXTERNAL STORAGE DEVICE
404 READING DEVICE
405 INPUT DEVICE,
406 OUTPUT DEVICE
407 COMMUNICATION DEVICE
   FIG. 5
110 RECIPIENT-SIDE DEVICE
120 SENDER-SIDE DEVICE
   FIG. 6
110 RECIPIENT-SIDE DEVICE
120 SENDER-SIDE DEVICE
   FIG. 7
140 COMMUNICATION LINE
210A RECIPIENT-SIDE DEVICE
210B SENDER-SIDE DEVICE
230 KEY MANAGEMENT CENTER-SIDED DEVICE
   FIG. 8
120 SENDER-SIDE DEVICE
211 INPUT UNIT
212 ARITHMETIC UNIT
213 RANDOM NUMBER GENERATING UNIT
214 ENCRYPTION/DECRYPTION UNIT
215 STORAGE UNIT
216 COMMUNICATION UNIT
217 OUTPUT UNIT
210A RECIPIENT-SIDE DEVICE
210B SENDER-SIDE DEVICE
   FIG. 9
230 KEY MANAGEMENT CENTER-SIDED DEVICE
231 INPUT UNIT
232 ARITHMETIC UNIT
233 KEY INFORMATION GENERATING UNIT
234 STORAGE UNIT
235 COMMUNICATION UNIT
236 OUTPUT UNIT
   FIG. 10
210A RECIPIENT-SIDE DEVICE
210B SENDER-SIDE DEVICE
230 KEY MANAGEMENT CENTER-SIDED DEVICE
   FIG. 11
210A RECIPIENT-SIDE DEVICE
210B SENDER-SIDE DEVICE
230 KEY MANAGEMENT CENTER-SIDED DEVICE
   FIG. 12
140 COMMUNICATION LINE
810 RECIPIENT-SIDE DEVICE
820 SENDER-SIDE DEVICE
   FIG. 13
810 RECIPIENT-SIDE DEVICE
811 INPUT UNIT
812 ARITHMETIC UNIT
813 KEY INFORMATION GENERATING UNIT
814 ENCRYPTION/DECRYPTION UNIT
815 STORAGE UNIT
816 COMMUNICATION UNIT
817 OUTPUT UNIT
   FIG. 14
820 SENDER-SIDE DEVICE
821 INPUT UNIT
822 ARITHMETIC UNIT
823 RANDOM NUMBER GENERATING UNIT
824 ENCRYPTION/DECRYPTION UNIT
825 STORAGE UNIT
826 COMMUNICATION UNIT
827 OUTPUT UNIT
   FIG. 15
810 RECIPIENT-SIDE DEVICE
820 SENDER-SIDE DEVICE
   FIG. 16
810 RECIPIENT-SIDE DEVICE
820 SENDER-SIDE DEVICE
   FIG. 17
810 RECIPIENT-SIDE DEVICE
820 SENDER-SIDE DEVICE
   FIG. 18
810 RECIPIENT-SIDE DEVICE
820 SENDER-SIDE DEVICE
   FIG. 19
140 COMMUNICATION LINE
910A RECIPIENT-SIDE DEVICE
910B SENDER-SIDE DEVICE
930 KEY MANAGEMENT CENTER-SIDED DEVICE
   FIG. 20
910A RECIPIENT-SIDE DEVICE
910B SENDER-SIDE DEVICE
911 INPUT UNIT
912 ARITHMETIC UNIT
913 RANDOM NUMBER GENERATING UNIT
914 ENCRYPTION/DECRYPTION UNIT
915 STORAGE UNIT
916 COMMUNICATION UNIT
917 OUTPUT UNIT
   FIG. 21
930 KEY MANAGEMENT CENTER-SIDED DEVICE
931 INPUT UNIT
932 ARITHMETIC UNIT
933 KEY INFORMATION GENERATING UNIT
934 STORAGE UNIT
935 COMMUNICATION UNIT
936 OUTPUT UNIT
   FIG. 22
910A RECIPIENT-SIDE DEVICE
910B SENDER-SIDE DEVICE
930 KEY MANAGEMENT CENTER-SIDED DEVICE
   FIG. 23
910A RECIPIENT-SIDE DEVICE
910B SENDER-SIDE DEVICE
930 KEY MANAGEMENT CENTER-SIDED DEVICE
   FIG. 24
910A RECIPIENT-SIDE DEVICE
910B SENDER-SIDE DEVICE
930 KEY MANAGEMENT CENTER-SIDED DEVICE
   FIG. 25
910A RECIPIENT-SIDE DEVICE
910B SENDER-SIDE DEVICE
930 KEY MANAGEMENT CENTER-SIDED DEVICE

What is claimed is:

1. A crypto-communication method by which a sender-side device generates and transmits a cryptogram of a message text and a recipient-side device receives and decrypts the cryptogram, the crypto-communication method comprising the steps, performed by one of the recipient-side device and a key management center-side device, of:
selecting random numbers s₁, s₂;
generating P, QεG₁ and a bilinear mapping e: G₁×G₁→G₂, as part of key information open to public;
generating P₁=s₁P and P₂=s₂P as part of the key information open to the public; and
transmitting the generated P, Q, e, P₁, P₂ to the sender-side device;
and the crypto-communication method further comprising the steps performed by the sender-side device of:
receiving P, Q, e, P₁, P₂ from the one of the recipient-side device and the key management center-side device;
calculating e(Q, P₁) and e(Q, P₂) by use of the received P, Q, e, P₁, P₂; and
generating a cryptogram to be transmitted to the recipient-side device by use of the calculated e (Q, P₁) and e (Q, P₂).

2. A crypto-communication method by which a sender-side device generates and transmits a cryptogram of a message text and a recipient-side device receives and decrypts the cryptogram,
(1) the crypto-communication method comprising the steps, performed by the recipient-side device, of:
generating a prime number q, an additive group G₁ of an order q, a multiplicative group G₂ of the order q, and a bilinear mapping e given from Equation 1;
[Equation 66]
e:G₁×G₁→G₂ (1)
selecting at random s₁, s₂εZ*_{q} and P, QεG₁;
calculating Equation 2;
$$\begin{matrix}[ Equation 2 ] & \\ \begin{matrix}{P}_{pub , 1} = {s}_{1} P , \\ {P}_{pub , 2} = {s}_{2} P\end{matrix} \} & ( 2 )\end{matrix}$$
setting SK_{A}=(s₁Q, s₂Q) as a decryption key, and PK_{A}=(q, G₁, G₂, e, m, n, P, P_{pub,1}, P_{pub,2}, H₁, H₂) as an encryption key, and storing the decryption key and the encryption key in a storage unit (where m and n represent natural numbers, and H₁, H₂ denote hash functions given by Equation 3); and
$$\begin{matrix}[ Equation 3 ] & \\ \begin{matrix}{H}_{1} : {G}_{2} \times {G}_{2} \to {\{ 0 , 1 \}}^{n} , \\ {H}_{2} : {G}_{1} \times {\{ 0 , 1 \}}^{n} \times {\{ 0 , 1 \}}^{n} \to {\{ 0 , 1 \}}^{m}\end{matrix} \} & ( 3 )\end{matrix}$$
outputting the encryption key PK_{A};
(2) the crypto-communication method further comprising the steps, performed by the sender-side device, of:
selecting at random rεZ_{q} with respect to a message text Mε{0,1}ⁿ;
calculating Equation 4 by use of the encryption key PK_{A} outputted by the recipient-side device; and
$$\begin{matrix}[ Equation 4 ] & \\ \begin{matrix}U = rP , \\ V = M ⊕ {H}_{1} ( {e ( Q , {P}_{1} )}^{r} , {e ( Q , {P}_{2} )}^{r} ) , \\ W = {H}_{2} ( U , V , M )\end{matrix} \} & ( 4 )\end{matrix}$$
transmitting calculated cryptogram C=(U, V, W) as a cryptogram of the message text M to the recipient-side device; and (3) the crypto-communication method further comprising the steps performed by the recipient-side device of:
calculating Mε{0,1}ⁿ from Equation 5 by use of the decryption key SK_{A} stored in the storage unit with respect to the cryptogram C=(U, V, W) received from the sender-side device;
[Equation 5]
M=V⊕H₁(e(s₁Q,U),e(s₂Q,U)) (5)
checking whether a checking formula in Equation 6 is satisfied or not; and
[Equation 6]
W=H₂(U,V,M) (6)
outputting a calculation result M as the message text if the checking formula is satisfied, and discarding the cryptogram C as an invalid cryptogram if the checking formula is not satisfied.

3. A crypto-communication method by which a sender-side device generates and transmits a cryptogram of a message text and a recipient-side device receives and decrypts the cryptogram,
(1) the crypto-communication method comprising the steps, performed by the recipient-side device, of:
generating a prime number q, an additive group G₁ of an order q, a multiplicative group G₂ of the order q, and a bilinear mapping e given from Equation 7;
[Equation 7]
e:G₁×G₁→G₂ (7)
selecting at random s₁, s₂εZ*_{q} and P, QεG₁;
calculating Equation 8;
$$\begin{matrix}[ Equation 8 ] & \\ \begin{matrix}{P}_{pub , 1} = {s}_{1} P , \\ {P}_{pub , 2} = {s}_{2} P\end{matrix} \} & ( 8 )\end{matrix}$$
setting SK_{A}=(s₁Q, s₂Q) as a decryption key and PK_{A}=(q, G₁, G₂, e, m, n, P, P_{pub,1}, P_{pub,2}, H₁, H₂, H₃) as an encryption key, and storing the decryption key and the encryption key in a storage unit (where m and n represent natural numbers, and H₁, H₂, and H₃ denote hash functions given by Equation 9); and
$$\begin{matrix}[ Equation 9 ] & \\ \begin{matrix}{H}_{1} : {G}_{2} \times {G}_{2} \to {\{ 0 , 1 \}}^{m} , \\ {H}_{2} : {\{ 0 , 1 \}}^{m} \to {\{ 0 , 1 \}}^{n} , \\ {H}_{3} : {\{ 0 , 1 \}}^{n} \times {\{ 0 , 1 \}}^{m} \to {ℤ}_{q}\end{matrix} \} & ( 9 )\end{matrix}$$
outputting the encryption key PK_{A};
(2) the crypto-communication method further comprising the steps, performed by the sender-side device, of:
selecting at random σε{0,1}^{m} with respect to a message text Mε{0,1}ⁿ;
calculating Equation 10 by use of the encryption key PK_{A} outputted by the recipient-side device;
[Equation 10]
r=H₃(M,σ) (10)
calculating Equation 11; and
$$\begin{matrix}[ Equation 11 ] & \\ \begin{matrix}U = rP , \\ V = σ ⊕ {H}_{1} ( {e ( Q , {P}_{1} )}^{r} , {e ( Q , {P}_{2} )}^{r} ) , \\ W = M ⊕ {H}_{2} ( σ )\end{matrix} \} & ( 11 )\end{matrix}$$
transmitting calculated cryptogram C=(U, V, W) as a cryptogram of the message text M to the recipient-side device; and
(3) the crypto-communication method further comprising the steps performed by the recipient-side device of:
calculating σε{0,1}^{m} from Equation 12 by use of the decryption key SK_{A} stored in the storage unit with respect to the cryptogram C=(U, V, W) received from the sender-side device;
[Equation 12]
σ=V⊕H₁(e(s₁Q,U),e(s₂Q,U)) (12)
calculating M from Equation 13;
[Equation 13]
M=H₂(σ)⊕W (13)
calculating rεZ_{q} from Equation 14;
[Equation 14]
r=H₃(M,σ) (14)
checking whether a checking formula in Equation 15 is satisfied or not; and
[Equation 15]
U=rP (15)
outputting a calculation result M as the message text if the checking formula is satisfied, and discarding the cryptogram C as an invalid cryptogram if the checking formula is not satisfied.

4. A crypto-communication method by which a sender-side device generates a cryptogram of a message text by use of a system parameter generated by a key management center-side device, and a recipient-side device decrypts the cryptogram by employing a secret key for ID-based encryption which is generated by the key management center-side device,
(1) the crypto-communication method comprising the steps performed by the key management center-side device of:
generating a prime number q, an additive group G₁ of an order q, a multiplicative group G₂ of the order q, and a bilinear mapping e given from Equation 16;
[Equation 16]
e:G₁×G₁→G₂ (16)
selecting at random s₀, s₁εZ*_{q} and PεG₁;
generating Equation 17;
$$\begin{matrix}[ Equation 17 ] & \\ \begin{matrix}{P}_{pub , 0} = {s}_{0} P , \\ {P}_{pub , 1} = {s}_{1} P\end{matrix} \} & ( 17 )\end{matrix}$$
storing (s₀, s₁) as a master key, and PK=(q, G₁, G₂, e, l, m, n, P, P_{pub,0}, P_{pub,1}, H₁, H₂, H₃, H₄, E, D) as the system parameter in a storage unit (where l, m, n represent natural numbers, E represents an encryption function in common key cryptography, D designates a decryption function in the common key cryptography, and H₁, H₂, H₃, and H₄ denote hash functions given by Equation 18);
$$\begin{matrix}[ Equation 18 ] & \\ \begin{matrix}{H}_{1} : {\{ 0 , 1 \}}^{*} \to {G}_{1} , {H}_{2} : {\{ 0 , 1 \}}^{*} \times {G}_{2} \times {G}_{2} \to {\{ 0 , 1 \}}^{l} , \\ {H}_{3} : {\{ 0 , 1 \}}^{*} \to {ℤ}_{q} \times {\{ 0 , 1 \}}^{m} , {H}_{4} : {\{ 0 , 1 \}}^{*} \to {\{ 0 , 1 \}}^{l}\end{matrix} \} & ( 18 )\end{matrix}$$
outputting the system parameter PK;
storing individual information ID_{A} of a recipient-side user which is received from the recipient-side device in the storage unit;
selecting at random b_{IDA}ε{0,1};
calculating Equation 19 by employing the master key (s₀, s₁); and
[Equation 19]
d_{ID}_{_{A,}}ᵢ=sᵢH₁(ID∥b_{ID}_{_{A}}) (i=0,1) (19)
outputting calculated SK_{A}=(b_{IDA}, d_{IDA,0}, d_{IDA,1}) as a private key of the recipient-side user;
(2) the crypto-communication method further comprising the steps performed by the sender-side device of:
selecting at random Rε{0, 1}^{l} with respect to the message text Mε{0,1}ⁿ;
calculating rεZ_{q} and Kε{0, 1}^{m} given in Equation 20 by use of the messages text M and R, the individual information ID_{A} received from the recipient-side device, and the system parameter PK output from the key management center-side device;
[Equation 20]
(r,K)=H₃(ID_{A},ID_{B},R) (20)
calculating Equation 21 (where E_{K}(M) represents a result of encrypting plaintext M with a data encryption key K); and
$$\begin{matrix}[ Equation 21 ] & \\ \begin{matrix}U = rP , {V}_{0} = R ⊕ {H}_{2} ( {ID}_{A} , e ( {{H}_{1} ( {ID}_{A} ‖ 0 ) , {P}_{pub , 0} )}^{r} , \\ e ( {{H}_{1} ( {ID}_{A} ‖ 0 ) , {P}_{pub , 1} )}^{r} ) , \\ {V}_{1} = R ⊕ {H}_{2} ( {ID}_{A} , e ( {{H}_{1} ( {ID}_{A} ‖ 1 ) , {P}_{pub , 0} )}^{r} , e ( {{H}_{1} ( {ID}_{A} ‖ 1 ) , {P}_{pub , 1} )}^{r} ) , \\ W = {E}_{K} ( M ) , Z = {H}_{4} ( M , R , {ID}_{A} , U , {V}_{0} , {V}_{1} , W )\end{matrix} \} & ( 21 )\end{matrix}$$
transmitting calculated cryptogram C=(U, V₀, V₁, W, Z) as a cryptogram to the recipient-side device; and
(3) the crypto-communication method further comprising the steps, performed by the recipient-side device, of:
calculating Rε{0, 1}^{l} given in Equation 22 by using the private key SK_{A} outputted from the key management center-side device with respect to the cryptogram C=(U, V₀, V₁, W, Z) received from the sender-side device;
[Equation 22]
R=V_{b}_{_{ID}}⊕H₂(ID_{A},e(d_{ID}_{_{A,}}₀,U),e(d_{ID}_{_{A,}}₁,U)) (93)
calculating rεZ_{q} and Kε{0, 1}^{m} by Equation 23;
[Equation 23]
(r,K)=H₃(ID_{A},ID_{B},R) (23)
calculating Mε{0, 1}ⁿ by Equation 24 (where D_{K}(Y) represents a result of decrypting a cryptogram Y by use of a key K);
[Equation 24]
M=D_{K}(W) (24)
checking whether a checking formula in Equation 25 is satisfied or not; and
$$\begin{matrix}[ Equation 25 ] & \\ \begin{matrix}U = rP , {V}_{0} = R ⊕ {H}_{2} ( {ID}_{A} , e ( {{H}_{1} ( {ID}_{A} ‖ 0 ) , {P}_{pub} )}^{r} ) , \\ {V}_{1} = R ⊕ {H}_{2} ( {ID}_{A} , e ( {{H}_{1} ( {ID}_{A} ‖ 1 ) , {P}_{pub} )}^{r} ) , \\ Z = {H}_{4} ( M , R , {ID}_{A} , U , {V}_{0} , {V}_{1} , W )\end{matrix} \} & ( 25 )\end{matrix}$$
outputting a calculation result M as the message text if the checking formula is satisfied, and discarding the cryptogram C as an invalid cryptogram if the checking formula is not satisfied.

5. A crypto-communication method according to claim 4, wherein the cryptogram is generated and decrypted by changing an input value, inputted to the hash functions H₁ to H₄, into another parameter.

6. A crypto-communication method by which a sender-side device generates a cryptogram of a message text by use of a system parameter generated by a key management center-side device, and a recipient-side device decrypts the cryptogram by employing a secret key for ID-based encryption which is generated by the key management center-side device,
(1) the crypto-communication method comprising the steps performed by the key management center-side device of:
generating a prime number q, an additive group G₁ of an order q, a multiplicative group G₂ of the order q, and a bilinear mapping e given from Equation 26;
[Equation 26]
e:G₁×G₁→G₂ (26)
selecting at random s₁₀, s₁₁, s₂₀, s₂₁εZ*_{q} and PεG₁;
generating Equation 27;
$$\begin{matrix}[ Equation 27 ] & \\ \begin{matrix}{P}_{pub , i 0} = {s}_{i 0} P , \\ {P}_{pub , i 1} = {s}_{i 1} P , \\ {P}_{pub , i} = {s}_{i 0} {s}_{i 1} P ( i = 1 , 2 )\end{matrix} \} & ( 27 )\end{matrix}$$
storing SK=(s₁₀, s₁₁, s₂₀, s₂₁) as a master key, and PK=(q, G₁, G₂, e, l, m, n, P, P_{pub,10}, P_{pub,11}, P_{pub,1}, P_{pub,20}, P_{pub,21}, P_{pub,2}, H₁H₂, H₃, H₄, E, D) as a system parameter in a storage unit (where l, m, and n represent natural numbers, E represents an encryption function in common key cryptography, D designates a decryption function in the common key cryptography, and H₁, H₂, H₃, and H₄ denote hash functions given by Equation 28);
$$\begin{matrix}[ Equation 28 ] & \\ \begin{matrix}{H}_{1} : {\{ 0 , 1 \}}^{*} \to {G}_{1} , {H}_{2} : {G}_{2} \times {G}_{2} \to {\{ 0 , 1 \}}^{l} , \\ {H}_{3} : {\{ 0 , 1 \}}^{*} \to {ℤ}_{q} \times {ℤ}_{q} \times {\{ 0 , 1 \}}^{m} , {H}_{4} : {\{ 0 , 1 \}}^{*} \to {\{ 0 , 1 \}}^{l}\end{matrix} \} & ( 28 )\end{matrix}$$
outputting the system parameter PK;
storing individual information ID_{A} of a recipient-side user which is received from the recipient-side device in the storage unit;
selecting at random b_{IDA}ε{0,1};
calculating Equation 29 by employing the master key SK; and
$$[ Equation 29 ] \\ {d}_{( i , {ID}_{A} )} = {{s}_{ib}}_{{ID}_{A}} {H}_{1} ( ID ) ( i = 1 , 2 ) \qquad ( 29 )$$
outputting calculated SK_{A}=(b_{IDA}, d_{(1, IDA)}, d_{(2, IDA)}) as a private key of the recipient-side user;
(2) the crypto-communication method further comprising the steps performed by the sender-side device of:
selecting at random Rε{0, 1}^{l} with respect to the message text Mε{0,1}ⁿ;
calculating r₀, r₁εZ_{q} and Kε{0, 1}^{m} given in Equation 30 by use of the messages text M and R, the individual information ID_{A} received from the recipient-side device, and the system parameter PK output from the key management center-side device;
[Equation 30]
(r₀r₁,K)=H₃(ID_{A},ID_{B},R) (30)
calculating Equation 31 (where E_{K}(M) represents a result of encrypting a plaintext M with a data encryption key K); and
$$\begin{matrix}[ Equation 31 ] & \\ \begin{matrix}{U}_{i 0} = {r}_{0} {P}_{pub , i 0} , {U}_{i 1} = {r}_{1} {P}_{pub , i 1} ( i = 1 , 2 ) \\ {V}_{0} = R ⊕ {H}_{2} ( {ID}_{A} , {e ( {H}_{1} ( {ID}_{A} ) , {P}_{pub , 1} )}^{{r}_{0}} , {e ( {H}_{1} ( {ID}_{A} ) , {P}_{pub , 2} )}^{{r}_{0}} ) \\ {V}_{1} = R ⊕ {H}_{2} ( {ID}_{A} , {e ( {H}_{1} ( {ID}_{A} ) , {P}_{pub , 1} )}^{{r}_{1}} , {e ( {H}_{1} ( {ID}_{A} ) , {P}_{pub , 2} )}^{{r}_{1}} ) \\ W = {E}_{K} ( M ) , Z = {H}_{4} ( M , R , {ID}_{A} , {U}_{10} , \\ {U}_{11} , {U}_{20} , {U}_{21} , {V}_{0} , {V}_{1} , W )\end{matrix} \} & ( 31 )\end{matrix}$$
transmitting calculated cryptogram C (U₁₀, U₁₁, U₂₀, U₂₁, V₀, V₁, W, Z) as a cryptogram to the recipient-side device; and
(3) the crypto-communication method further comprising the steps, performed by the recipient-side device, of:
calculating Rε={0, 1}^{l} given in Equation 32 by using the private key SK_{A} outputted from the key management center-side device with respect to the cryptogram C=(U₁₀, U₁₁, U₂₀, U₂₁, V₀, V₁, W, Z) received from the sender-side device;
$$\begin{matrix}[ Equation 32 ] & \\ R = {V}_{1 - {b}_{ID}} ⊕ {H}_{2} ( {ID}_{A} , e ( {d}_{( 1 , {ID}_{A} )} , {U}_{1 , ( 1 - {b}_{I D} )} ) , e ( {d}_{( 2 , {ID}_{A} )} , {U}_{2 , ( 1 - {b}_{I {D}_{A}} )} ) ) & ( 32 )\end{matrix}$$
calculating r₀, r₁εZ_{q} and Kε{0, 1}^{m} by Equation 33;
[Equation 33]
(r₀,r₁,K)=H₃(ID_{A},ID_{B},R) (33)
calculating R′ε{0,1}^{l} given in Equation 34;
$$\begin{matrix}[ Equation 34 ] & \\ {R}^{′} = {V}_{{b}_{ID}} ⊕ {H}_{2} ( {ID}_{A} , {e ( {H}_{1} ( {ID}_{A} ) , {P}_{pub , 1} )}^{{r}_{1 - {b}_{{ID}_{A}}}^{- 1} {r}_{{b}_{{ID}_{A}}}} , {e ( {H}_{1} ( {ID}_{A} ) , {P}_{pub , 2} )}^{{r}_{1 - {b}_{{ID}_{A}}}^{- 1} {r}_{{b}_{{ID}_{A}}}} ) & ( 34 )\end{matrix}$$
checking whether a first checking formula in Equation 35 is satisfied or not;
[Equation 35]
R=R′,Uᵢⱼ=rⱼP_{pub,ij}(1≦i≦2,0≦j≦1) (35)
calculating Equation 36 (where D_{K} (Y) represents a result of decrypting a cryptogram Y by use of a key K) if the first checking formula is satisfied;
[Equation 36]
M=D_{K}(W) (36)
checking whether a second checking formula in Equation 37 is satisfied or not; and
[Equation 37]
Z=H₄(M,R,ID_{A},U₁₀,U₁₁,U₂₀,U₂₁,V₀,V₁,W) (37)
outputting a calculation result M as the message text if the second checking formula is satisfied, and discarding the cryptogram C as an invalid cryptogram if the first checking formula or the second checking formula is not satisfied.

7. A crypto-communication method according to claim 6, wherein the cryptogram is generated and decrypted by changing an input value, inputted to the hash functions H₁ to H₄, into another parameter.

8. A crypto-communication system comprising a sender-side device which generates and transmits a cryptogram of a message text, and a recipient-side device which receives and decrypts the cryptogram, wherein an arithmetic unit of one of the recipient-side device and a key management center-side device is configured to perform:
a process of selecting random numbers s₁ and s₂;
a process of generating P, QεG₁ and a bilinear mapping e: G₁×G₁→G₂ as part of key information open to public;
a process of generating P₁=s₁P and P₂=s₂P as part of the key information open to the public; and
a process of transmitting the generated P, Q, e, P₁, P₂ to the sender-side device via a communication unit; and
wherein an arithmetic unit of the sender-side device is configured to perform:
a process of receiving P, Q, e, P₁, P₂ from the recipient-side device or the key management center-side device via the communication unit;
a process of calculating e(Q, P₁) and e(Q, P₂) by use of the received P, Q, e, P₁, P₂; and
a process of generating a cryptogram to be transmitted to the recipient-side device by use of the calculated e(Q, P₁) and e(Q, P₂).

9. A recipient-side device which generates an encryption key used by a sender-side device to generate a cryptogram of a message text, the recipient-side device comprising an arithmetic unit which is configured to perform:
a process of generating a prime number q, an additive group G₁ of an order q, a multiplicative group G₂ of the order q, and a bilinear mapping e given from Equation 38;
[Equation 38]
e:G₁×G₁→G₂(38)
a process of selecting at random s₁, s₂εZ*_{q} and P, QεG₁;
a process of calculating Equation 39;
$$\begin{matrix}[ Equation 39 ] & \\ \begin{matrix}{P}_{pub , 1} = {s}_{1} P , \\ {P}_{pub , 2} = {s}_{2} P\end{matrix} \} & ( 39 )\end{matrix}$$
a process of setting SK_{A}=(s₁Q, s₂Q) as a decryption key, and PK_{A}=(q, G₁, G₂, e, m, n, P, P_{pub,1}, P_{pub,2}, H₁, H₂) as an encryption key, and storing both the decryption key and the encryption key in a storage unit (where m and n represent natural numbers, and H₁, H₂ denote hash functions given by Equation 40); and
$$\begin{matrix}[ Equation 40 ] & \\ \begin{matrix}{H}_{1} : {G}_{2} \times {G}_{2} \to {\{ 0 , 1 \}}^{n} , \\ {H}_{2} : {G}_{1} \times {\{ 0 , 1 \}}^{n} \times {\{ 0 , 1 \}}^{n} \to {\{ 0 , 1 \}}^{m}\end{matrix} \} & ( 40 )\end{matrix}$$
a process of outputting the encryption key PK_{A}.

10. A recipient-side device which generates an encryption key used by a sender-side device to generate a cryptogram of a message text, the recipient-side device comprising an arithmetic unit which is configured to perform:
a process of generating a prime number q, an additive group G₁ of an order q, a multiplicative group G₂ of the order q, and a bilinear mapping e given from Equation 41;
[Equation 41]
e:G₁×G₁→G₂ (41)
a process of selecting at random s₁, s₂εZ*_{q} and P, QεG₁;
a process of calculating Equation 42;
$$\begin{matrix}[ Equation 42 ] & \\ \begin{matrix}{P}_{pub , 1} = {s}_{1} P , \\ {P}_{pub , 2} = {s}_{2} P\end{matrix} \} & ( 42 )\end{matrix}$$
a process of setting SK_{A}=(s₁Q, s₂Q) as a decryption key, and PK_{A}=(q, G₁, G₂, e, m, n, P, P_{pub,1}, P_{pub,2}, H₁, H₂, H₃) as an encryption key, and storing both the decryption key and the encryption key in a storage unit (where m and n represent natural numbers, and H₁, H₂, H₃ denote hash functions given by Equation 43); and
$$\begin{matrix}[ Equation 43 ] & \\ \begin{matrix}{H}_{1} : {G}_{2} \times {G}_{2} \to {\{ 0 , 1 \}}^{m} , \\ {H}_{2} : {\{ 0 , 1 \}}^{m} \to {\{ 0 , 1 \}}^{n} , \\ {H}_{3} : {\{ 0 , 1 \}}^{n} \times {\{ 0 , 1 \}}^{m} \to {ℤ}_{q}\end{matrix} \} & ( 43 )\end{matrix}$$
a process of outputting the encryption key PK_{A}.

11. A key management center-side device which generates a system parameter used by a sender-side device to generate a cryptogram of a message text, the key management center-side device comprising an arithmetic unit which is configured to perform:
a process of generating a prime number q, an additive group G₁ of an order q, a multiplicative group G₂ of the order q, and a bilinear mapping e given from Equation 44;
[Equation 44]
e:G₁×G₁→G₂ (44)
a process of selecting at random s₀, s₁εZ*_{q} and PεG₁;
a process of generating Equation 45;
$$\begin{matrix}[ Equation 45 ] & \\ \begin{matrix}{P}_{pub , 0} = {s}_{0} P , \\ {P}_{pub , 1} = {s}_{1} P\end{matrix} \} & ( 45 )\end{matrix}$$
a process of storing (s₀, s₁) as a master key and PK=(q, G₁, G₂, e, l, m, n, P, P_{pub,0}, P_{pub,1}, H₁, H₂, H₃, H₄, E, D) as the system parameter in a storage unit (where l, m, and n represent natural numbers, E represents an encryption function in common key cryptography, D designates a decryption function in the common key cryptography, and H₁, H₂, H₃, and H₄ denote hash functions given by Equation 46);
$$\begin{matrix}[ Equation 46 ] & \\ \begin{matrix}{H}_{1} : {\{ 0 , 1 \}}^{*} \to {G}_{1} , {H}_{2} : {\{ 0 , 1 \}}^{*} \times {G}_{2} \times {G}_{2} \to {\{ 0 , 1 \}}^{l} , \\ {H}_{3} : {\{ 0 , 1 \}}^{*} \to {ℤ}_{q} \times {\{ 0 , 1 \}}^{m} , {H}_{4} : {\{ 0 , 1 \}}^{*} \to {\{ 0 , 1 \}}^{l}\end{matrix} \} & ( 46 )\end{matrix}$$
a process of outputting the system parameter PK;
a process of storing individual information ID_{A} of a recipient-side user which is received from the recipient-side device in the storage unit;
a process of selecting at random b_{IDA}ε{0,1};
a process of calculating Equation 47 by employing the master key (s₀, s₁); and
[Equation 47]
d_{ID}_{_{A,}}ᵢ=sᵢH₁(ID∥b_{ID}_{_{A}}) (i=0,1) (47)
a process of outputting calculated SK_{A}=(b_{IDA}, d_{IDA,0}, d_{IDA,1}) as a private key of the recipient-side user.

12. A key management center-side device which generates a system parameter used by a sender-side device to generate a cryptogram of a message text, the key management center-side device comprising an arithmetic unit which is configured to perform:
a process of generating a prime number q, an additive group G₁ of an order q, a multiplicative group G₂ of the order q, and a bilinear mapping e given from Equation 48;
[Equation 48]
e:G₁×G₁→G₂ (48)
a process of selecting at random s₁₀, s₁₁, s₂₀, s₂₁εZ*_{q} and PεG₁;
a process of generating Equation 49;
$$\begin{matrix}[ Equation 49 ] & \\ \begin{matrix}{P}_{pub , i 0} = {s}_{i 0} P , \\ {P}_{pub , i 1} = {s}_{i 1} P , \\ {P}_{pub , i} = {s}_{i 0} {s}_{i 1} P ( i = 1 , 2 )\end{matrix} \} & ( 49 )\end{matrix}$$
a process of storing SK=(s₁₀, s₁₁, s₂₀, s₂₁) as a master key, and PK=(q, G₁, G₂, e, l, m, n, P, P_{pub,10}, P_{pub,11}, P_{pub,1}, P_{pub,20}, P_{pub,21}, P_{pub,2}, H₁, H₂, H₃, H₄, E, D) as a system parameter in a storage unit (where l, m, and n represent natural numbers, E represents an encryption function in common key cryptography, D designates a decryption function in the common key cryptography, and H₁, H₂, H₃, and H₄ denote hash functions given by Equation 50);
$$\begin{matrix}[ Equation 50 ] & \\ \begin{matrix}{H}_{1} : {\{ 0 , 1 \}}^{*} \to {G}_{1} , {H}_{2} : {G}_{2} \times {G}_{2} \to {\{ 0 , 1 \}}^{l} , \\ {H}_{3} : {\{ 0 , 1 \}}^{*} \to {ℤ}_{q} \times {ℤ}_{q} \times {\{ 0 , 1 \}}^{m} , {H}_{4} : {\{ 0 , 1 \}}^{*} \to {\{ 0 , 1 \}}^{l}\end{matrix} \} & ( 50 )\end{matrix}$$
a process of outputting the system parameter PK;
a process of storing individual information ID_{A} of a recipient-side user which is received from the recipient-side device in the storage unit;
a process of selecting at random b_{IDA}ε{0,1};
a process of calculating Equation 51 by employing the master key SK; and
$$\begin{matrix}[ Equation 51 ] & \\ {d}_{( i , {ID}_{A} )} = {{s}_{ib}}_{{ID}_{A}} {H}_{1} ( ID ) ( i = 1 , 2 ) & ( 51 )\end{matrix}$$
a process of outputting calculated SK_{A}=(b_{IDA}, d_{(1, IDA)}, d_{(2, IDA)}) as a private key of the recipient-side user.

13. A program product including a storage medium storing a program which causes a computer to function as a recipient-side device which generates an encryption key used by a sender-side device to generate a cryptogram of a message text, the program comprising program code which causes an arithmetic unit of the computer to execute:
a process of generating a prime number q, an additive group G₁ of an order q, a multiplicative group G₂ of the order q, and a bilinear mapping e given from Equation 52;
[Equation 52]
e:G₁×G₁→G₂ (52)
a process of selecting at random s₁, s₂εZ*_{q} and P, QεG₁;
a process of calculating Equation 53;
$$\begin{matrix}[ Equation 53 ] & \\ \begin{matrix}{P}_{pub , 1} = {s}_{1} P , \\ {P}_{pub , 2} = {s}_{2} P\end{matrix} \} & ( 53 )\end{matrix}$$
a process of setting SK_{A}=(s₁Q, s₂Q) as a decryption key and PK_{A}=(q, G₁, G₂, e, m, n, P, P_{pub,1}, P_{pub,2}, H₁, H₂) as an encryption key, and storing both the decryption key and the encryption key in a storage unit (where m and n represent natural numbers, and H₁ and H₂ denote hash functions given by Equation 54); and
$$\begin{matrix}[ Equation 54 ] & \\ \begin{matrix}{H}_{1} : {G}_{2} \times {G}_{2} \to {\{ 0 , 1 \}}^{n} , \\ {H}_{2} : {G}_{1} \times {\{ 0 , 1 \}}^{n} \times {\{ 0 , 1 \}}^{n} \to {\{ 0 , 1 \}}^{m}\end{matrix} \} & ( 54 )\end{matrix}$$
a process of outputting the encryption key PK_{A}.

14. A program product including a storage medium storing a program which causes a computer to function as a recipient-side device which generates an encryption key used by a sender-side device to generate a cryptogram of a message text, the program comprising program code which causes an arithmetic unit of the computer to execute:
a process of generating a prime number q, an additive group G₁ of an order q, a multiplicative group G₂ of the order q, and a bilinear mapping e given from Equation 55;
[Equation 55]
e:G₁×G₁→G₂ (55)
a process of selecting at random s₁, s₂εZ*_{q} and P, QεG₁;
a process of calculating Equation 56;
$$\begin{matrix}[ Equation 56 ] & \\ \begin{matrix}{P}_{pub , 1} = {s}_{1} P , \\ {P}_{pub , 2} = {s}_{2} P\end{matrix} \} & ( 56 )\end{matrix}$$
a process of setting SK_{A}=(s₁Q, s₂Q) as a decryption key, and PK_{A}=(q, G₁, G₂, e, m, n, P, P_{pub,1}, P_{pub,2}, H₁, H₂, H₃) as an encryption key, and storing the decryption key and the encryption key in a storage unit (where m and n represent natural numbers, and H₁, H₂, and H₃ denote hash functions given by Equation 57); and
$$\begin{matrix}[ Equation 57 ] & \\ \begin{matrix}{H}_{1} : {G}_{2} \times {G}_{2} \to {\{ 0 , 1 \}}^{m} , \\ {H}_{2} : {\{ 0 , 1 \}}^{m} \to {\{ 0 , 1 \}}^{n} , \\ {H}_{3} : {\{ 0 , 1 \}}^{n} \times {\{ 0 , 1 \}}^{m} \to {ℤ}_{q}\end{matrix} \} & ( 57 )\end{matrix}$$
a process of outputting the encryption key PK_{A}.

15. A program product including a storage medium storing a program which causes a computer to function as a key management center-side device which generates a system parameter used by a sender-side device to generate a cryptogram of a message text, the program comprising program code which causes an arithmetic unit of the computer to execute:
a process of generating a prime number q, an additive group G₁ of an order q, a multiplicative group G₂ of the order q, and a bilinear mapping e given from Equation 58;
[Equation 58]
e:G₁×G₁→G₂ (58)
a process of selecting at random s₀, s₁εZ*_{q} and PεG₁;
a process of generating Equation 59;
$$\begin{matrix}[ Equation 59 ] & \\ \begin{matrix}{P}_{pub , 0} = {s}_{0} P , \\ {P}_{pub , 1} = {s}_{1} P\end{matrix} \} & ( 59 )\end{matrix}$$
a process of storing (s₀, s₁) as a master key and PK=(q, G₁, G₂, e, l, m, n, P, P_{pub,0}, P_{pub,1}, H₁, H₂, H₃, H₄, E, D) as the system parameter in a storage unit (where l, m, and n represent natural numbers, E represents an encryption function in common key cryptography, D designates a decryption function in the common key cryptography, and H₁, H₂, H₃, and H₄ denote hash functions given by Equation 60);
$$\begin{matrix}[ Equation 60 ] & \\ \begin{matrix}{H}_{1} : {\{ 0 , 1 \}}^{*} \to {G}_{1} , {H}_{2} : {\{ 0 , 1 \}}^{*} \times {G}_{2} \times {G}_{2} \to {\{ 0 , 1 \}}^{l} , \\ {H}_{3} : {\{ 0 , 1 \}}^{*} \to {ℤ}_{q} \times {\{ 0 , 1 \}}^{m} , {H}_{4} : {\{ 0 , 1 \}}^{*} \to {\{ 0 , 1 \}}^{l}\end{matrix} \} & ( 60 )\end{matrix}$$
a process of outputting the system parameter PK;
a process of storing individual information ID_{A} of a recipient-side user which is received from the recipient-side device in the storage unit;
a process of selecting at random b_{IDA}ε{0,1};
a process of calculating Equation 61 by employing the master key (s₀, s₁); and
[Equation 61]
d_{ID}_{_{A,}}ᵢ=sᵢH₁(ID∥b_{ID}_{_{A}}) (i=0,1) (61)
a process of outputting calculated SK_{A}=(b_{IDA}, d_{IDA,0}, d_{IDA,1}) as a private key of the recipient-side user.

16. A program product including a storage medium storing a program which causes a computer to function as a key management center-side device which generates a system parameter used by a sender-side device to generate a cryptogram of a message text, the program comprising program code which causes an arithmetic unit of the computer to execute:
a process of generating a prime number q, an additive group G₁ of an order q, a multiplicative group G₂ of the order q, and a bilinear mapping e given from Equation 62;
[Equation 62]
e:G₁×G₁→G₂ (62)
a process of selecting at random s₁₀, s₁₁, s₂₀, s₂₁εZ*_{q} and PεG₁;
a process of generating Equation 63;
$$\begin{matrix}[ Equation 63 ] & \\ \begin{matrix}{P}_{pub , i 0} = {s}_{i 0} P , \\ {P}_{pub , i 1} = {s}_{i 1} P , \\ {P}_{pub , i} = {s}_{i 0} {s}_{i 1} P ( i = 1 , 2 )\end{matrix} \} & ( 63 )\end{matrix}$$
a process of storing SK=(s₁₀, s₁₁, s₂₀, s₂₁) as a master key, and PK=(q, G₁, G₂, e, l, m, n, P, P_{pub,10}, P_{pub,11}, P_{pub,1}, P_{pub,20}, P_{pub,21}, P_{pub,2}, H₁, H₂, H₃, H₄, E, D) as a system parameter in a storage unit (where l, m, and n represent natural numbers, E represents an encryption function in common key cryptography, D designates a decryption function in the common key cryptography, and H₁, H₂, H₃, and H₄ denote hash functions given by Equation 64);
$$\begin{matrix}[ Equation 64 ] & \\ \begin{matrix}{H}_{1} : {\{ 0 , 1 \}}^{*} \to {G}_{1} , {H}_{2} : {G}_{2} \times {G}_{2} \to {\{ 0 , 1 \}}^{l} , \\ {H}_{3} : {\{ 0 , 1 \}}^{*} \to {ℤ}_{q} \times {ℤ}_{q} \times {\{ 0 , 1 \}}^{m} , {H}_{4} : {\{ 0 , 1 \}}^{*} \to {\{ 0 , 1 \}}^{l}\end{matrix} \} & ( 64 )\end{matrix}$$
a process of outputting the system parameter PK;
a process of storing individual information ID_{A} of a recipient-side user which is received from the recipient-side device in the storage unit;
a process of selecting at random b_{IDA}ε{0,1};
a process of calculating Equation 65 by employing the master key SK; and
$$\begin{matrix}[ Equation 65 ] & \\ {d}_{( i , {ID}_{A} )} = {{s}_{ib}}_{{ID}_{A}} {H}_{1} ( ID ) ( i = 1 , 2 ) & ( 65 )\end{matrix}$$
a process of outputting calculated SK_{A}=(b_{IDA}, d_{(1, IDA)}, d_{(2, IDA)}) as a private key of the recipient-side user.

17. A crypto-communication method by which a sender-side device generates and transmits a cryptogram of a message text, and a recipient-side device receives and decrypts the cryptogram, the crypto-communication method comprising the steps performed by one of the recipient-side device and a key management center-side device of:
generating a plurality of pairs of public keys and secret keys;
generating public key information containing a plurality of the public keys generated in the step of generating keys; and
generating secret key information containing a plurality of the secret keys generated in the step of generating keys;
the crypto-communication method further comprising the steps performed by the sender-side device of:
acquiring the public key information; and
generating a cryptogram in which a message is encrypted by using all of the plurality of the public keys contained in the public key information;
and the crypto-communication method further comprising the steps performed by the recipient-side device of:
acquiring the cryptogram; and
decrypting the cryptogram by using the secret key information.

18. A crypto-communication method according to claim 17, wherein arbitrary encryption systems can be selected for the public key and the secret key.

19. A crypto-communication system comprising a sender-side device which generates and transmits a cryptogram of a message text and a recipient-side device which receives and decrypts the cryptogram,
wherein an arithmetic unit of one of the recipient-side device and a key management center-side device is configured to perform:
a key generating process of generating a plurality of pairs of public keys and secret keys;
a process of generating public key information containing a plurality of the public keys generated in the key generating process; and
a process of generating secret key information containing a plurality of the secret keys generated in the key generating process;
wherein an arithmetic unit of the sender-side device is configured to perform:
a process of acquiring the public key information; and
a process of generating a cryptogram in which a message is encrypted by using all of the plurality of the public keys contained in the public key information; and
wherein an arithmetic unit of the recipient-side device is configured to perform:
a process of acquiring the cryptogram; and
a process of decrypting the cryptogram with the secret key information.

20. A crypto-communication system according to claim 19, wherein arbitrary encryption systems can be selected for the public key and the secret key.
